(19) United States
(12) Patent Application Publication
(10) Pub. No.: US 2004/0031015 A1
(43) Pub. Date: Feb. 12, 2004

(54) System and method for manipulation of software

(75) Inventors: Mohamed Ben-Romdhane, Irvine, CA (US); Harshal A. Mulherkar, Irvine, CA (US); Ramanand V. Mandayam, Irvine, CA (US)

Correspondence Address: PROCOPIO, CORY, HARGREAVES & SAVITCH, LLP, 530 B STREET, SUITE 2100, SAN DEIGO, CA, 92101-4469, US

(73) Assignee: Conexant Systems, Inc.

(21) Appl. No.: 09/865,300

(22) Filed: May 24, 2001

(51) Int. Cl. G06F 9/44

(52) U.S. Cl. 717/107; 717/116

(57) ABSTRACT

A system and method for manipulating software is provided. The system analyzes a body of source code and derives a set of components from the software architecture inherent in the body of source code. The system further determines the internal and external functional and data dependencies of each component and the control flow of the software and creates an information model that represents the components, their dependencies, and the control flow of the program. Additionally, the system provides a graphical interface that presents the information model and allows the macro and micro structure of the model to be viewed and modified. Furthermore, components can be combined and separated to refine the software architecture represented by the information model and documentation and new source code can be provided for inclusion in the information model.

### BACKGROUND OF THE INVENTION

1. Field of the Invention

The present invention generally relates to the manipulation of software and more particularly relates to the manipulation of software components that comprise a software application.

2. Related Art

After several decades and more of software development, a very large body of software has been developed for various industries, applications, and devices. The computer industry in particular has developed a staggering amount of legacy software and continues to do so each day.

As a result, recovery and re-architecting of legacy software is necessary to upgrade software systems that exist in all types of industries. Companies from just about every industry across the board from aerospace to financial have invested in significant amounts of software solutions over the past several decades. Local and federal governments are also extremely heavily invested in software solutions to carry out their many automated tasks.

Typical problems associated with the massive amount of software that is being generated include comprehension of the software by modern engineers and reuse of the software. There are few tools on the shelves today that are designed to aid modern engineers comprehend software.

These conventional tools may be helpful, but are extremely difficult to use with large bodies of software because conventional tools suffer from the inability to portray a macro view of the software. Furthermore, such tools are typically used to complement software development tools and are not easily adapted for comprehension of software. A further disadvantage of conventional tools is that they do not provide any information regarding the inherent software architecture of the software.

Similarly, very few tools exist today that help engineers reuse software. Typically, the conventional tools that do exist require significant effort and man hours to extract a small portion of reusable software from a large body of software. Furthermore, these conventional tools are typically limited to providing dependency hints to the engineer, thus requiring that significant effort be consumed in the actual identification of reusable software and its packaging for efficient redeployment. This can cause great fluctuation in the integrity of reclaimed software modules, based solely upon the expertise of the software engineer.

Furthermore, spending a significant amount of time attempting to understand the software and recapture the software for reuse in modern products defeats the main purpose of software reuse and legacy code recovery which is to cut design time and optimize the Time-To-Market (“TTM”) for the new products. Typically, when upgrading hardware the legacy software must be ported to the new hardware. Such activity can take a significant amount of time in either manual porting and rewriting or in redesigning the entire software architecture. For example, many air-flight control systems in use today are still running on out-dated hardware because of the massively prohibitive cost (in time and in dollars) of upgrading such mammoth and mission critical systems.

Additionally, a repository provides indexed storage for all sorts of documents including plans, standards, functional requirements, design documents, software files, executable object code, test-cases, results of verification and so on. These documents are intended to be made available for future reference or for reuse. Such a repository, however, lacks a unified approach that correlates the documentation with the relevant portions of source code in order to bring out the information that is truly essential for efficient reuse of the software.

The disadvantage of conventional solutions is that they focus primarily on the micro structure of a body of software. Code comprehension with conventional tools is also limited due to the lack of an ability to divine any meaningful macro structure from the body of software. If an engineer is tasked with extracting a reusable software component from a body of software, a very time consuming and tediously manual process will be required. The process is so time consuming that it typically defeats the primary focus and the basic advantages obtained by software reuse, which is time savings.

Conventional systems and methods for software comprehension and reuse presently have significant shortcomings. The problems associated with these shortcomings and the advancing needs of the industry to recover and reuse software in a timely manner have created a need for a system and method that overcomes these problems. In addition, there is a desire and a need for more comprehensive software manipulation functionality such as modeling, visualization, architecting, optimization, and distribution. The present invention addresses such problems by providing a solution that has not previously been proposed.

### SUMMARY OF THE INVENTION

The present invention provides a system and method for enabling the modeling, visualization, comprehension, reuse, architecting, optimization, and distribution of software.

The modeling aspect allows a software program to be analyzed and transformed into an information model that is comprised of the constituent components of the software program.

The visualization aspect allows the information model to be graphically presented to a design engineer with data dependencies, functional dependencies, and control flow indicators.

The comprehension aspect allows a design engineer to more quickly and completely understand the inner workings of the software program by perceiving its component elements, their organization, and relation.

The software reuse aspect enables a design engineer to reuse existing software programs by identifying inherent software components and extracting the interfaces to those components. This process allows the “black box” wholesale reuse of components.

The architecting aspect allows a design engineer to rearrange the inherent architecture in a software program, add new components to enhance the architecture of a software program, and create new software program architectures.

The optimization aspect allows a design engineer to cull desirable functionality from a software program and create a new software program optimized for the desired functionality.

The distribution aspect allows software intellectual property (“IP”) to be centrally maintained, previewed, and distributed across a network medium.

Finally, the scope of the present invention fully encompasses other embodiments that are recognizable to those skilled in the art, although not set forth in the summary.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a high level flow diagram illustrating an example embodiment of the present invention;

FIG. 2 is a network diagram illustrating an overview of a system for manipulation of software according to an embodiment of the present invention;

FIG. 3 is a block diagram illustrating an example server architecture in a system for manipulation of software according to an embodiment of the present invention;

FIG. 4 is a system flow diagram illustrating an example embodiment of the present invention;

FIG. 5 is a block diagram illustrating an example database containing native source code files in a system for manipulation of software;

FIG. 5A is a flow diagram illustrating an example parsing of source code files in a system for manipulation of software;

FIG. 6 is a block diagram illustrating an example database containing language dependant format files in a system for manipulation of software;

FIG. 6A is a flow diagram illustrating an example composing of language dependent format files in a system for manipulation of software;

FIG. 6B is a flow diagram illustrating an example composing of source code files into language independent format files in a system for manipulation of software;

FIG. 7 is a block diagram illustrating an example information model generator in a system for manipulation of software;

FIG. 8 is a block diagram illustrating an example database containing an information model in a system for manipulation of software;

FIG. 8A is a block diagram illustrating an example information model in a system for manipulation of software;

FIG. 8B is a block diagram illustrating an example information model and supporting derivative LIF objects in a system for manipulation of software;

FIG. 8C is a block diagram illustrating an example tiled view of components of a system architecture in a system for manipulation of software;

FIG. 9 is a block diagram illustrating an example information model viewer in a system for manipulation of software;

FIG. 9A is a software application window illustrating an example information model viewer according to one embodiment of the present invention;

FIG. 9B is a software application window illustrating an example component viewer according to one embodiment of the present invention;

FIG. 9C is a software application window illustrating an example calling tree viewer according to one embodiment of the present invention;

FIG. 10 is a block diagram illustrating an example information model editor in a system for manipulation of software;

FIG. 10A is a software application window illustrating an example model editor according to one embodiment of the present invention;

FIG. 10B is a software application window illustrating an example document linking and upload utility according to one embodiment of the present invention;

FIG. 11 is a block diagram illustrating an example system architect in a system for manipulation of software;

FIG. 11A is a software application window illustrating an example system architect designer according to one embodiment of the present invention;

FIG. 12 is a software application window illustrating an example component download utility according to one embodiment of the present invention;

FIG. 13 is a flow chart illustrating an example process for organizing language independent format objects into a derivative language independent format object based on configuration specifications according to an embodiment of the present invention;

FIG. 14 is a flow chart illustrating an example process for presenting an information model according to an embodiment of the present invention;

FIG. 15 is a flow chart illustrating an example process for optimizing an information model according to an embodiment of the present invention;

FIG. 16 is a flow chart illustrating an example process for searching an information model according to an embodiment of the present invention;

FIG. 17 is a flow chart illustrating an example process for creating a template of an information model according to an embodiment of the present invention;

FIG. 18 is a block diagram illustrating an exemplary computer system as may be used in connection with various embodiments described herein.

### DETAILED DESCRIPTION OF THE INVENTION

Certain embodiments as disclosed herein provide for a system and method for manipulation of software. For example, one aspect of the invention disclosed herein allows for the source code of a software program to be broken down into its basic components and graphically presented in a fashion that describes the interdependencies between the components of the software program and the high level procedural flow of the program. Advantageously, portrayal of the architecture of a software program in this fashion allows engineers to understand, build upon, and re-use the source code.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

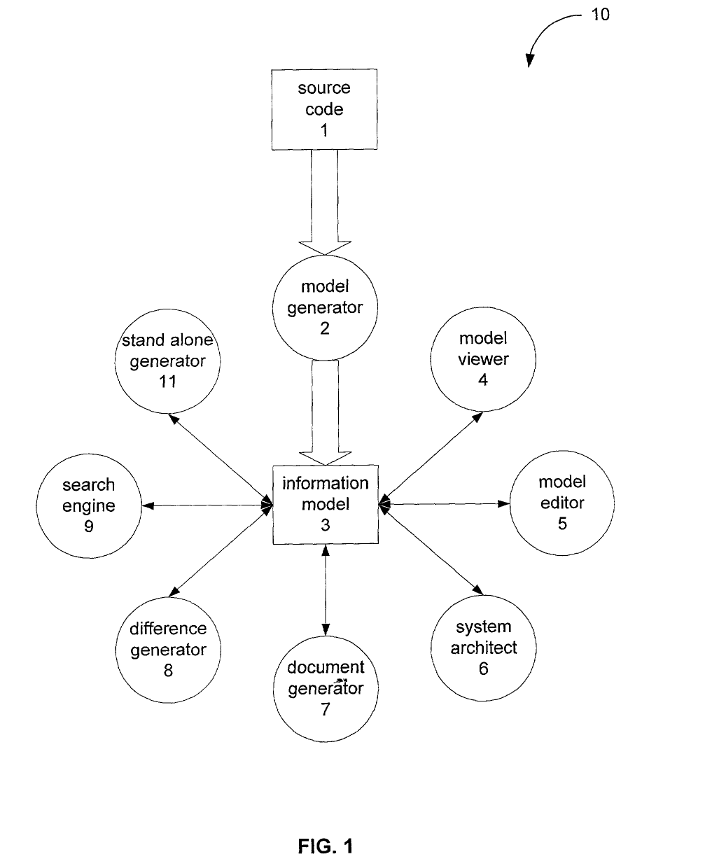

FIG. 1 is a flow diagram illustrating an example embodiment of a system 10 according to the present invention. System 10 can be comprised of a body of source code 1, a model generator 2, an information model 3, a model viewer 4, a model editor 5, a system architect 6, a document generator 7, a difference generator 8, a search engine 9, and a stand alone generator 11.

In this exemplary embodiment, a software application has a set of source code files 1 that comprise the entire application. Source code 1 is analyzed by model generator 2 to create information model 3. Information model 3 can then be presented to a user through model viewer 4. Information model 3 can also be enriched by model editor 5, which allows supporting information and documentation to be associated with information model 3. System architect 6, in communication with information model 3, enables the presentation and modification of the software application architecture. System architect 6 can also create a new information model (not shown) from a user defined architecture.

Document generator 7 can extract and collate the information contained in system 10 and can also create a document containing that information. Difference generator 8 can compare at least two information models and generate a resulting information model that represents the differences between the compared models. Search engine 9 enables searching of one or more information models based upon a search request and presents the search results. Stand alone generator 11 enables the creation of a modified system (not shown) comprising an information model browser tailored to a specific body of native source code. In one embodiment, stand alone generator 11 can selectively enable/disable features of the tailored information model browser.

For example, stand alone generator 11 may be employed to create a custom system for a particular body of native source code. In one embodiment, a customer may provide the source code to an operator of the system 10. The operator may run the native source code through the system 10 and in particular through the stand alone generator 11. The stand alone generator 11 preferably creates a package that can be distributed back to the customer that allows the customer to view an information model of the native source code. Additional functionality may or may not be provided to the customer. For instance, the ability to merge components (system architect), view and add documentation (model editor), search the information model (model search engine), and generate a model document (document generator), may be selectively provided to the customer. Accordingly, the stand alone generator 11 provides a functionality that serves as a basis for a desirable business model. For example, certain entities may not be interested in purchasing or leasing a complete system 10 for generating and/or manipulating an information model. Thus, through the use of the stand alone generator 11, such entities will have the option of purchasing or leasing, at a correspondingly reduced rate, a modified system (not shown) that provides a pre-generated information model for a given application, along with a user-desired subset of the various features available in the complete system 10.

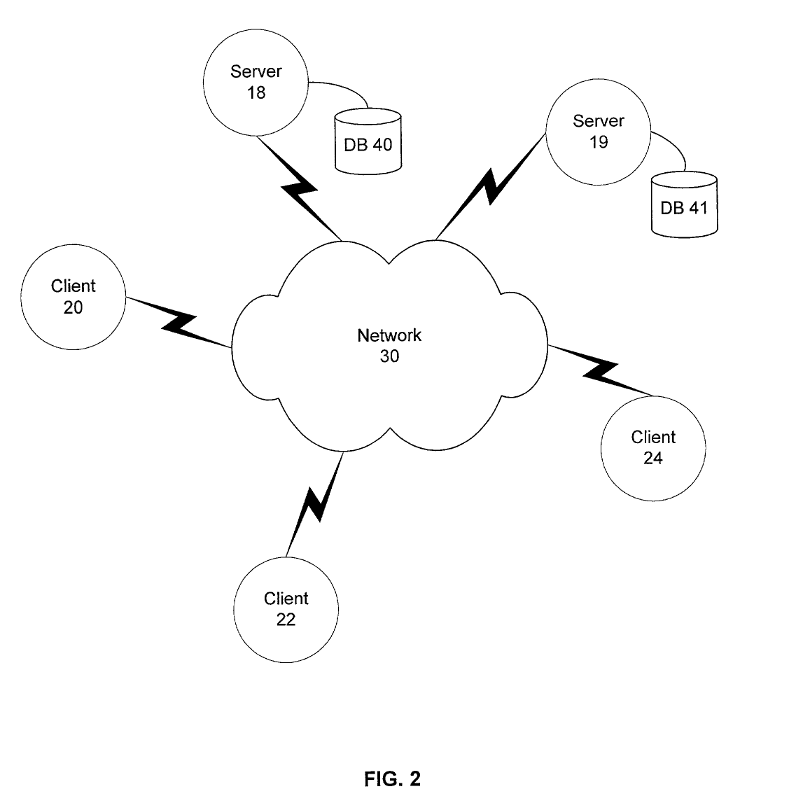

FIG. 2 is a block diagram illustrating an information system network. It is understood in the art that software applications can be implemented as a stand alone operation, or as a part of an information system network. The system and method of the present invention is also capable of being implemented as a stand alone operation or as a part of an information system network as shown in FIG. 2. A simplified diagram of an information system network comprises a network 30 that enables communication between one or more clients 20, 22, 24, one or more servers 18 and 19, and one or more databases 40 and 41.

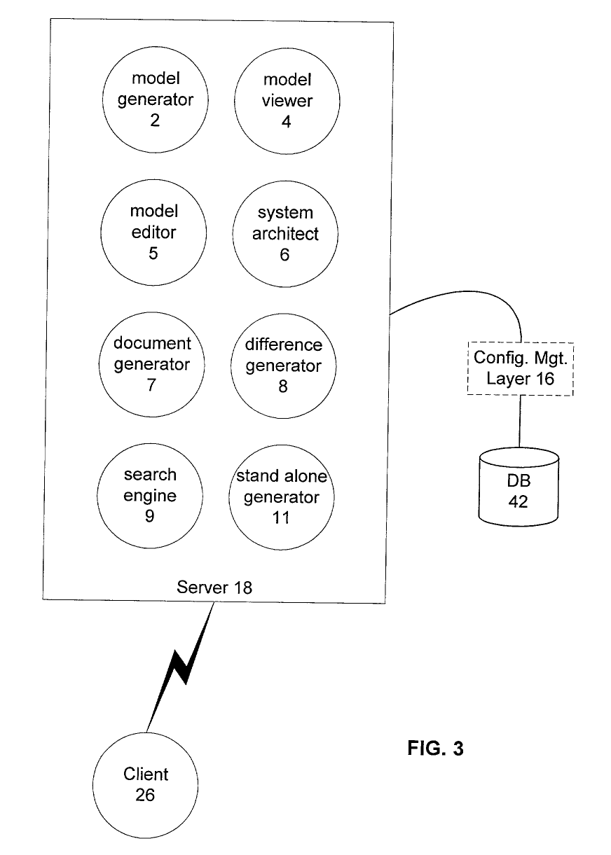

As previously stated, the system and method of the present invention may be implemented as a stand alone or networked application. In a preferred embodiment, the system and method of the present invention shall be described within a networked configuration. FIG. 3 is an embodiment where the functional modules of FIG. 1 are resident in a server, although it is understood that such functionality may be distributed between one or more servers and/or clients, or fully resident on a server device or a client device in a stand alone embodiment.

In one embodiment, server 18 may be comprised of a model generator 2, a model viewer 4, a model editor 5, a system architect 6, a document generator 7, a difference generator 8, a model search engine 9, and a stand alone generator 11. Furthermore, server 18 may be communicatively coupled with a client 26 and a database 42. Communication between server 18 and client 26 preferably takes place over a computer network (not shown). Alternatively, communication between server 18 and client 26 may take place over a direct physical connection or a wireless connection. Optionally, a configuration management layer 16 may be present between server 18 and database 42.

Database 42 may be comprised of data germane to the operation of a system for manipulation of software. Database 42 may contain a plurality of records or files relating to various software programs, information models, and clients. For example, database 42 may contain numerous sets of source code files, each set relating to a particular software program. Additionally, database 42 may contain a plurality of information models and their related files (such as documentation files and derivative LIF objects) as well as data relating to the various clients that may access server 18.

Furthermore, database 42 may be optimized to provide efficient collection, storage, and retrieval of data related to the visual presentation of software architecture. Database 42 may also be comprised of several logically or physically discrete distributed databases that can be united by common normalization of the stored data and a common data retrieval scheme. For example, such a distributed scheme for database 42 may advantageously be employed in a system that comprises more than one server 18. In such an embodiment, each discrete server 18 may house a portion of the distributed database 42.

Database 42 may be organized as a set of records or as files in a hierarchical file system. For example, database 42 may be populated with a set of records that conform to a commercial database format, such as Oracle® or Microsoft Access®. In one embodiment, the files comprising each discrete software program can be located within a single directory in a hierarchical file system. Furthermore, various subdirectories may be employed to more granularly organize the data files comprising the software program. Database 42 may also employ a configuration management utility (not shown) to facilitate access to the stored information, such as client data, information models, and the various files of a software program.

Database 42 may also include various sets of native source code files. The source code files may be arranged hierarchically or they may be arranged such that all files are stored in a single directory. In addition to the source code files, database 42 may contain intermediate versions of the source code files. For example, a parser may process each source code file while creating an information model and the parsing output may be stored as a separate file in database 42. In one embodiment, files parsed can be stored in a language dependent format (“LDF”). Such an intermediate format may be proprietary or well known, such as an abstract syntax tree (“AST”) format or the Stanford University Intermediate Format (“SUIF”). An example language dependent format is described in greater detail below.

Additionally, database 42 may contain files that comprise an information model and files that are related to information models. For example, an information model may be comprised of a plurality of language independent format (“LIF”) objects that are generated from the LDF files. An LIF object is preferably a collection of data that defines and describes a single component. An LIF object may comprise one or more files on one or more file systems (or one or more tables in one or more databases, etc.). An LIF object may also contain templates or placeholders for documentation to enrich the model. The set of LIF objects that comprises the information model preferably constitutes a baseline for the information model where each component in the baseline information model is associated with a single LIF object. An example language independent format is described in greater detail below.

Other types of files that may be stored in database 42 include supporting documentation template files that describe components and various other characteristics of an information model. Also, a series of derivative LIF objects may be stored in database 42. A derivative LIF object can describe the structural orientation of the components that are present in the information model. Advantageously, this allows the structure of the information model to be modified and rearranged with new derivative LIF objects without having to modify the underlying LIF objects that constitute the baseline information model.

Additionally, database 42 may advantageously contain a plurality of information models. In one embodiment, server 18 may present information regarding the available information models to a requesting client. Preferably, clients such as client 26 may access a plurality of information models stored in database 42. For example, server 18 may present a list of available information models to client 26. Client 26 may then select the desired information model and server 18 can provide that information model to client 26 from database 42.

In one embodiment, the list of available information models presented to client 26 may be filtered by server 18 based upon certain permissions. For example, client 26 may be required to provide authentication information to server 18 during the connection process. The authentication information may then constrain the ability of client 26 to view only that data in database 42 for which client 26 has been approved access. Such authentication procedures and access control capabilities (i.e. system logins and permissions) are well known in the art and are therefore not described in detail herein.

An additional function of database 42 can be to store file information relating to existing clients. For example, client 26 may be provided with secure access to information models, source code archives, and other data relevant to visual presentation of software architecture through server 18. The client information may help to facilitate secure access to sensitive data by providing the necessary authentication and permissions structure. For example, client 26 may connect to server 18 using a username/password combination that allows server 18 to provide certain protected and secure information to client 26.

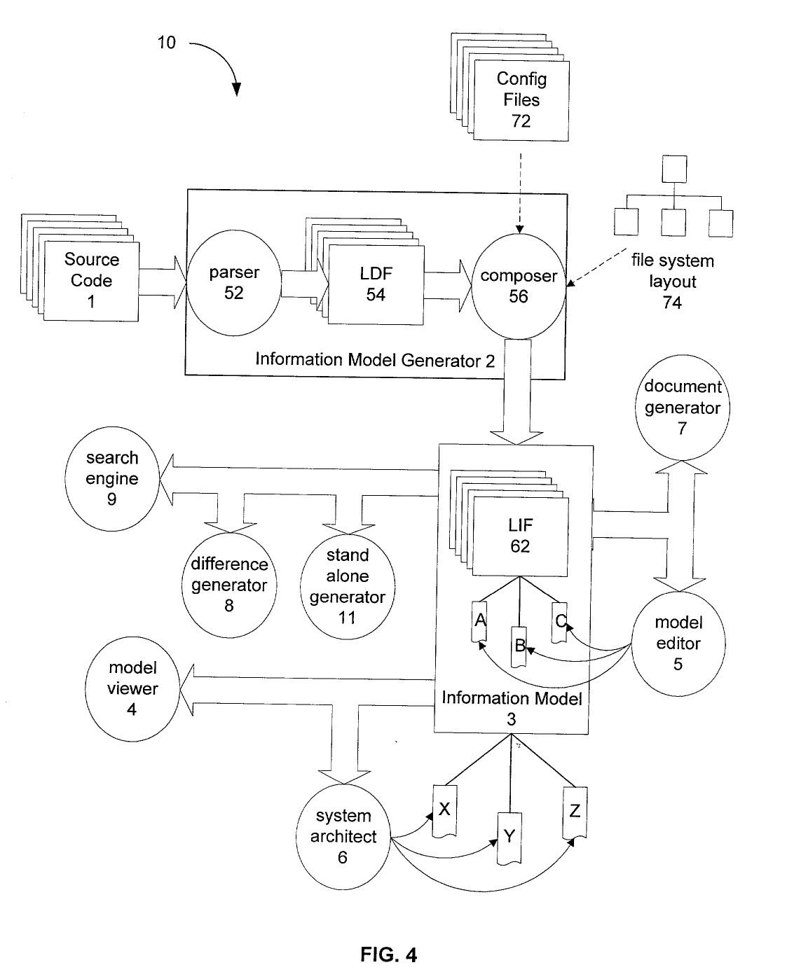

FIG. 4 is a flow diagram illustrating an example embodiment of the present invention. In this exemplary embodiment, system 10 may contain a set of source code files 1 that comprise the entire source code of a software application. In system 10, source code files 1 are processed by information model generator 2 to create an information model 3. During the processing, information model generator 2 may gather input from configuration files 72 and file system layout 74, which preferably represents the file system layout for source code files 1.

Information model generator 2 can be comprised of a parser 52 that reads source code files 1 and creates LDF files 54. Information model generator 2 may also be comprised of a composer 56 that reads LDF 54 and creates a set of LIF objects 62 that comprise information model 3. Information model 3 may also be comprised of a plurality of documentation templates A, B, and C. Additionally, information model 3 may be associated with a plurality of derivative LIF objects X, Y, and Z.

System 10 may also be comprised of various tools and utilities that provide design engineers with the ability to interact with information model 3. For example, utilities and tools that may be provided include: a model viewer 4, a model editor 5, a system architect 6, a document generator 7, a difference generator 8, a search engine 9, and a stand alone generator 11, just to name a few.

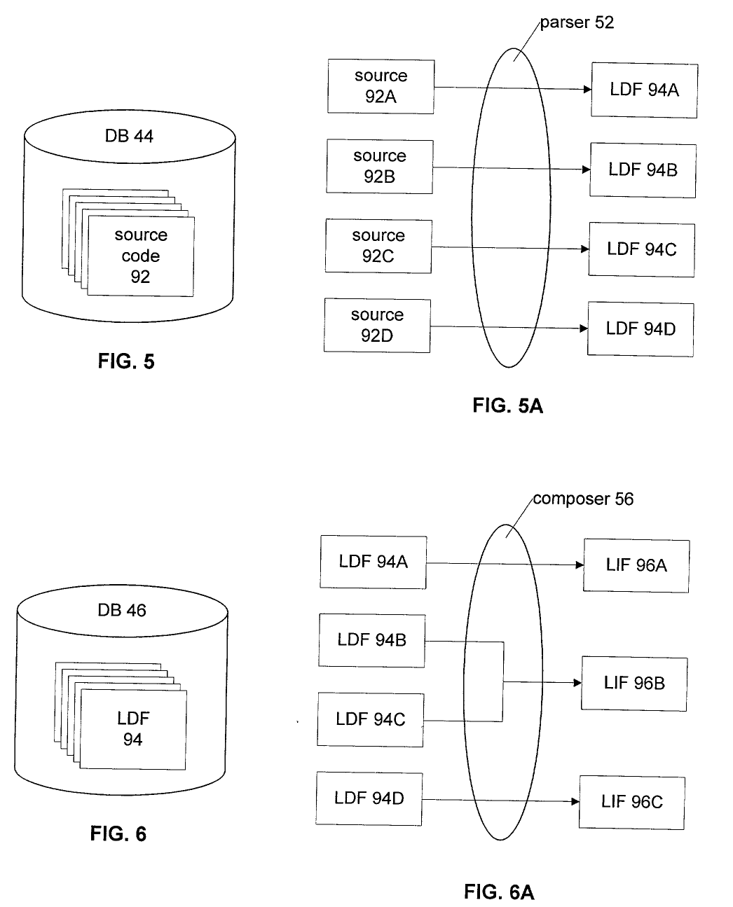

The separate components of system 10 will now be described in greater detail. Source code files 1 may be stored by system 10 using a variety of storage techniques. For example, FIG. 5 is a block diagram illustrating an example database 44 in a system for manipulation of software. Database 44 may contain a set of source code files, such as source code 92. A plurality of sets of source code may be stored in database 44. Database 44 may store the various sets of source code files in a file system hierarchy that includes directories, sub-directories, and files. Alternatively, database 44 may store a set of source code files, such as source code 92, in a more traditional database format using records with indices and the like. A variety of other data storage methods and techniques may also be employed by database 44, as will be evident to one having skill in the art.

The various sets of source code files can be collected together for more efficient storage. Alternatively, each set of source code files, such as source code 92, may be stored together with the LDFs, LIFs, documentation templates, and derivative LIF objects that comprise the information model. For example, in a file system structure for database 44, a directory may exist that houses a particular software application. Subdirectories may exist for housing source code 92, the LDFs, the LIFs, the documentation templates, and the derivative LIF objects. For organizational purposes, parent, or top level directory may be appropriately named for the software program. The subdirectories may also be named according to their contents.

In one embodiment, database 44 may contain the data files that comprise the source code 92 of a software program. Advantageously, the files comprising source code 92 may be stored together with their associated information model. Additionally, the files comprising source code 92 may be stored in a compressed format to maximize the storage space in database 44.

In an alternative embodiment, the files comprising source code 92 may be stored in a hierarchical file system structure. This structure preferably groups the source files together in an organized fashion such that the files that comprise a particular component are grouped together in a single directory. Organizing the files into a cascading group of directories, with each directory representing a component of the system may advantageously provide an inherent structure to the software architecture for the body of source code and ultimately for the associated information model.

Advantageously, system 10, as presented in FIG. 4, can provide a visual representation of the underlying system architecture inherent in a body of source code such as source code 1. System 10 can also allow a design engineer that is unfamiliar with the native programming language of source code 1 to understand the inner workings of the software and comprehend the nature of foreign language source code, legacy source code, and the like.

Continuing with reference to FIGS. 1 and 4, generator 2 preferably performs the function of creating an information model 3 from source code 1. Preferably information model 3 represents, in condensed format, the control flow, functional dependencies, data dependencies, and component hierarchy that comprise the software architecture inherent in the body of source code 1. Additionally, information model 3 can include documentation templates A, B, and C that describe the various components.

A component in information model 3 may comprise a collection of coherent modules, procedures, and functions contained within one or more source code files that perform a set of functions in order to satisfy a set of design requirements. A component may be derived from or extend the functionality found in the various software layers such as application software layers, protocol stack layers, hardware abstraction layers, device drivers, etc. that are included in source code 1. A component can also extend its functionality for use by other components through an application programming interface (not shown). Additionally, a component may be comprised of a portion of a single file, multiple files, several subsets of different files, or various combinations of complete files and subsets of files. Otherwise stated, a component is preferably an aggregate of executable code found in the body of source code 1.

The generator 2 advantageously analyzes source code 1 and determines the functional dependencies, data dependencies, control flow, and hierarchies of the software architecture inherent in the body of source code 1. Additionally, the generator 2 associates related files (or subsets thereof) into components and determines the interdependencies and hierarchies of the various components.

For example, generator 2 may be provided with the location of source code 1 that represents the software application to be analyzed, parsed, and composed into an information model. Once the files in source code 1 have been accessed, generator 2 may extract the control flow, functional dependencies, and data dependencies from the individual files, organize related files or subsets thereof into components, and create the information model. Furthermore, generator 2 may combine two or more components into a larger component to provide an initial structure or architecture for information model 3.

Advantageously generator 2 may comprise a parser 52 and a composer 56. In one embodiment, generator 2 can create the information model in a single step process. Alternatively, generator 2 can create the information model in a two step process. For example, first, the body of source code 1 that comprises the software application is consulted and analyzed. Preferably, parser 52 handles this function. Parser 52 can be a utility that reads through each individual source code file to determine the structural detail within the file. For example, the data elements, functional elements, and control elements within the file may be part of the structural detail culled from the file by parser 52.

Preferably, parser 52 analyzes each file in source code 1 and creates a correlating LDF file. Upon completion of the analysis of each file, an aggregate set of LDF files, LDF 54, is created. Preferably, LDF 54 contains data elements, structural elements, control flow elements, functional elements, enriching elements, and all other information needed to create an information model. The intermediate format files in LDF 54 are dependent upon the native source code language in which the software application was written. Advantageously, parser 52 may be modified or replaced in order to process native source code files in different programming languages.

For example, parser 52 may read a particular file and determine that there are three functions defined within the file. Moreover, parser 52 may determine the names of each of the functions contained within the file and the function calls made by the file. Additionally, parser 52 may determine that two functions are called from within the file. In one embodiment, the function of parser 52 may be complete after each file has been analyzed and the internal functions and function calls have been determined.

Parser 52 may also be required to determine the data dependencies for each file. The data dependencies for a file may include all global variables referenced (used or modified) by the file, data required by the functions that comprise the file's interface, and data passed to external functions called by the file. Parser 52 may read each source code file that comprises the body of source code 1 and determine the data dependencies of the file.

Parser 52 may also be required to determine the control flow within each file and between files. The control flow within a file may include the step-by-step instruction sequence contained within the file. Parser 52 may read each source code file that comprises the body of source code 1 and determine the control flow within each file and between the various files.

Parser 52 may also extract additional structural detail or data from a native source code file. Such additional elements may include those elements that are well known in the art to comprise an AST or an SUIF file. For example, comments from within the source code can be extracted by parser 52 for inclusion in the resulting LDF file.

FIG. 5A is a block diagram illustrating the conversion of native source code files 92A-D into intermediate format files LDF 94A-D by parser 52. Preferably, there is a one to one correlation between source code files 92A-D and their parsed counterparts, LDF files 94A-D. In alternative embodiments, other correlation ratios may exist between the source code files and the intermediate format files. As stated above, the LDF files can be in various formats such as SUIF, AST format, or a custom or proprietary format. Preferably, parser 52 converts the source code files into the LDF files. An example language dependent format is described in greater detail below.

Referring back to FIGS. 1 and 4, generator 2 also comprises composer 56. The function of composer 56 is preferably to create information model 3. In one embodiment, composer 56 may create an information model by analyzing LDF files 54 and generating LIF objects 62. The LDF files 54 can be accessed by composer 56 from a storage area or directly from parser 52. Additionally, composer 56 may derive a component based architecture inherent within the body of source code 1 based upon input from configuration files 72 or based upon the file system layout 74 for the files comprising source code 1.

For example, once the set of files LDF 54 is created, composer 56 analyzes each LDF file and generates an LIF object. Preferably, a discrete LIF object is created for each component in the resulting information model. In addition to creating LIF objects, composer 56 may also create a set of documentation templates, including, for example, files A, B, and C. Preferably, one documentation template is created for each structural element specified in each LIF object. Additionally, each documentation template is preferably associated with a specific LIF object. The resulting files, including LIF 62 and documentation files A, B, and C, constitute the newly created information model 3.

In one embodiment, composer 56 can give the newly created information model some initial structure. For example, each component in a new information model is typically created as a peer component to each other component in the model. Therefore, information models may initially have a flat structure. However, composer 56 may receive configuration input through configuration files 72 or file system layout 74. This input may instruct composer 56 to provide some initial hierarchical structure to the peer level components of the newly created information model.

Preferably, any initial structure created by composer 56 does not modify the underlying LIF objects. For example, LIF 62 can represent an atomic baseline structure for information model 3. Therefore, in order to preserve this baseline structure, composer 56 may create an initial derivative LIF object, such as X, for information model 3.

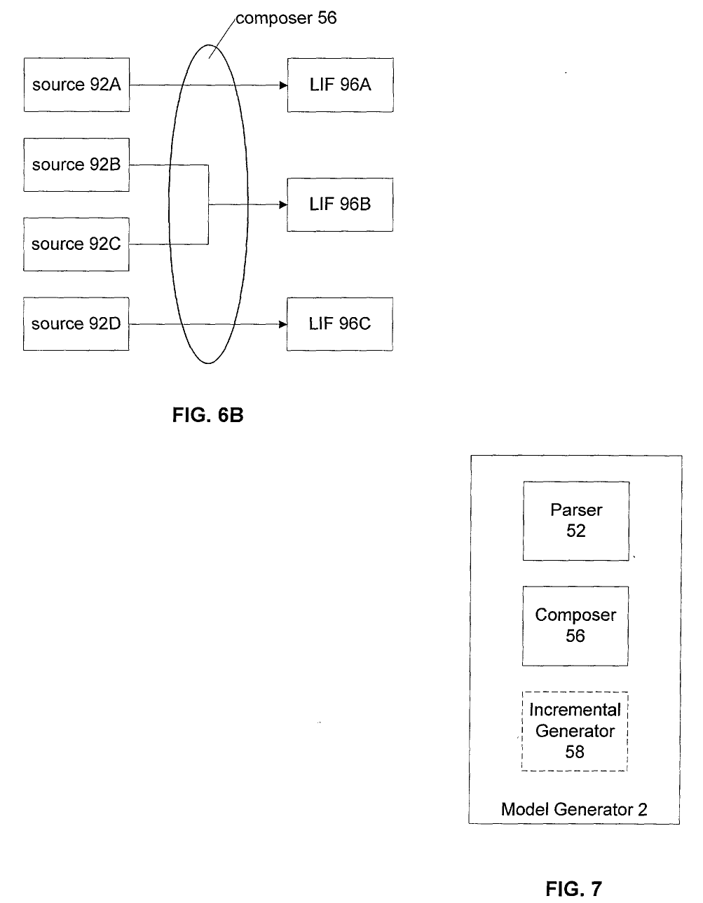

FIG. 6 is a block diagram illustrating an example database 46 in a system for manipulation of software. Database 46 may contain a set of intermediate format files, such as LDF 94. LDF 94 may be comprised of a plurality of LDF files. A plurality of sets of intermediate format files may be stored in database 46. In one embodiment, database 46 may store the various sets of intermediate format files in a file system hierarchy that includes directories, sub-directories, and files. Alternatively, database 46 may store a set of intermediate format files, such as LDF 94, in a more traditional database format using records with indices and the like. A variety of other data storage methods and techniques may also be employed by database 46, as will be evident to one having skill in the art.

The various sets of intermediate format files can be collected together by database 46 for more efficient storage. Alternatively, each set of intermediate format files, such as LDF 94, may be stored together with the native source code files, LIFs, documentation templates, and derivative LIF objects that comprise the information model. Advantageously, the files comprising the information model may be stored in a compressed format to maximize the storage space in database 46.

Composer 56 may also combine information obtained from one or more LDFs into an LIF object. Additionally, composer 56 may create an initial derivative LIF objects based on the file system structure of the body of native source code or based on input received from design engineers, for example through a configuration file.

In the translation, composer 56 generates an LIF object from one or more LDF files. By separating the structure of the data in an LIF object from the content, the composer enables the extension of an LIF object by user defined data structuring elements. For example, such a separation of structure from content may be implemented by the combination of a document type definition (“DTD”) specification to define the structure of the LIF object and an extensible markup language (“XML”) specification to define the contents of the LIF object. In one embodiment, the LIF object generated by composer 56 may conform to a DTD specification. An example DTD specification format is described in greater detail below.

In an alternative embodiment, an LIF object may be extended with user defined elements to broaden the functionality of the system or the component. Such user defined elements preferably allow for customizable data, functional, or control elements to be included in the information model. It is understood that a person having ordinary skill in the art would be capable of translating a native source code file or an LDF file into an LIF object using a formal description of the syntax and semantics of the DTD that specifies the structure and contents of the LIF object. An example DTD specification format is described in greater detail below.

Furthermore, composer 56 can translate LDF files to LIF objects in a one to one fashion or composer 56 may combine two or more LDF files and translate them into a single LIF object. Advantageously, instructions for how to combine one or more LDF files into a single LIF object can be provided to composer 56 through a configuration file or by the inherent hierarchical structure in the file system housing the body of native source code. Preferably, the output of composer 56 is a set of LIF objects that each represent a single component of the information model.

FIG. 6A is a block diagram illustrating the conversion of intermediate format LDF files 94A-D into LIF objects 96A-C by composer 56. In one embodiment, there can be a one-to-one relation between the LDF files and their corresponding LIF objects. Alternative embodiments are also possible where the ratio between the number of LDF files and LIF objects can be other than a one-to-one ratio. For example, LDF 94A may be composed directly into LIF 96A while LIF 96B can be composed of both LDF 94B and LDF 94C. The LIF objects can preferably be created in various independent formats that eliminate any dependency on the native source code language of the underlying source code files.

In an alternative embodiment, composer 56 may translate the set of LDF files into LIF objects and create a set of peer components. Composer 56 can then create an initial derivative LIF object based on input received from design engineers through a configuration file or based on the inherent hierarchical structure of the file system that contains the body of native source code. In this fashion, the initial step of creating the information model advantageously includes providing structure, rather than a simple set of peer components.

Composer 56 can also associate related portions of files into components. For example, composer 56 may determine that files are related based on a common scheme of control and data dependencies. In one embodiment, the characteristics sought by composer 56 can be designated in a configuration file. For example, a configuration file may co-exist in the database with the body of source code and describe certain attributes that would cause two files to be related and thereby combined into a single LIF object (component) by composer 56.

In one embodiment, certain attributes may be used by composer 56 to determine how to relate sections of source code into a single component. Examples of these attributes may include a co-reference (where each file references the other through an external function call), a common reference (where each file references the same external function call or set of external function calls), and a common interface (where each file is referenced by the same external file), just to name a few.

In an alternative embodiment, composer 56 may associate related LDF files into LIF objects (equivalently components) based on the hierarchical structure and organization of the source code files within the database or file system. For example, the files that comprise the body of source code may be stored in a file system with directories, sub-directories and individual files. Composer 56 may create a component for each directory and sub-directory within the file system. The individual LDF files corresponding to the source code files in a common directory may then be associated as sub-components within the larger directory component in which they are contained.

Furthermore, composer 56 may make each file that comprises the body of source code a separate component. In such an embodiment, the storage structure of the body of source code may not provide any inherent structure to the information model. Therefore, composer 56 may translate each LDF file into an LIF object where all resulting LIF objects represent peer components in the information model. In an alternative embodiment, composer 56 may also create a derivative LIF object that provides some structural organization to the components so that all components of the information model are not initially peer components.

FIG. 6B is a block diagram illustrating the direct conversion of native source code files 92A-D into language independent format objects LIF 96A-C by composer 56. Such a conversion is enabled either by an end user providing a configuration specification to the composer or by the composer heuristically identifying (based on the file system structure of the source code) the components of an information model. There can be a one to one ratio between the source code files and their LIF object counterparts. However, other ratios may also be present when the source code files are composed into LIF objects. For example, source code file 92A may be composed directly into LIF 96A while LIF 96B is composed of both source code file 92B and source code file 92C. Composer 56 converts the source code files directly into the LIF objects, bypassing the creation of intermediate LDF files. Thus, although creation of intermediate format files (e.g. LDF files) is one possible step in creating the LIF object for a component in an information model, this step is not necessary. Additionally, a single step composer 56 may be enhanced or modified in order to process native source code files in various different programming languages. In one embodiment, a modular software component may be added to composer 56 to supplement the various native source code languages composer 56 can process.

In an alternative embodiment, information model generator 2 may also include an incremental model generator 58, as illustrated in FIG. 7. Incremental generator 58 advantageously can recreate all or a portion of an information model. For example, the entire information model can be recreated from the body of native source code, which may include modifications or additions from the original body of source code used to create the previous version of the information model.

Alternatively, incremental generator 58 can recreate a portion of an information model by processing only those native source code files that have been added or modified since the previous version of the information model was created. For example, native source code files that have been added or modified can be re-parsed into LDF files, re-combined (if necessary) and re-composed into LIF objects and their associated documentation templates. Additionally, a new derivative LIF object can be created by incremental generator 58 that includes the newly added or updated LIF objects as components in the information model.

Referring back to FIGS. 1 and 4, information model 3 may be comprised of a plurality of LIF objects, such as LIF 62. Each individual LIF object comprising LIF 62 may have a plurality of associated document templates A, B, and C. Additionally, information model 3 can have a plurality of associated derivative LIF objects X, Y, and Z.

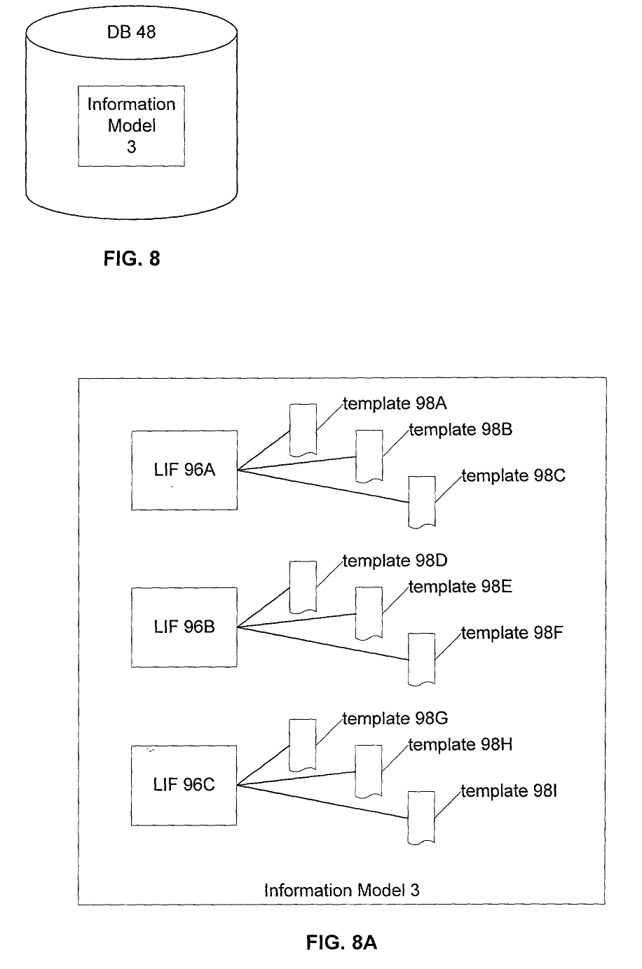

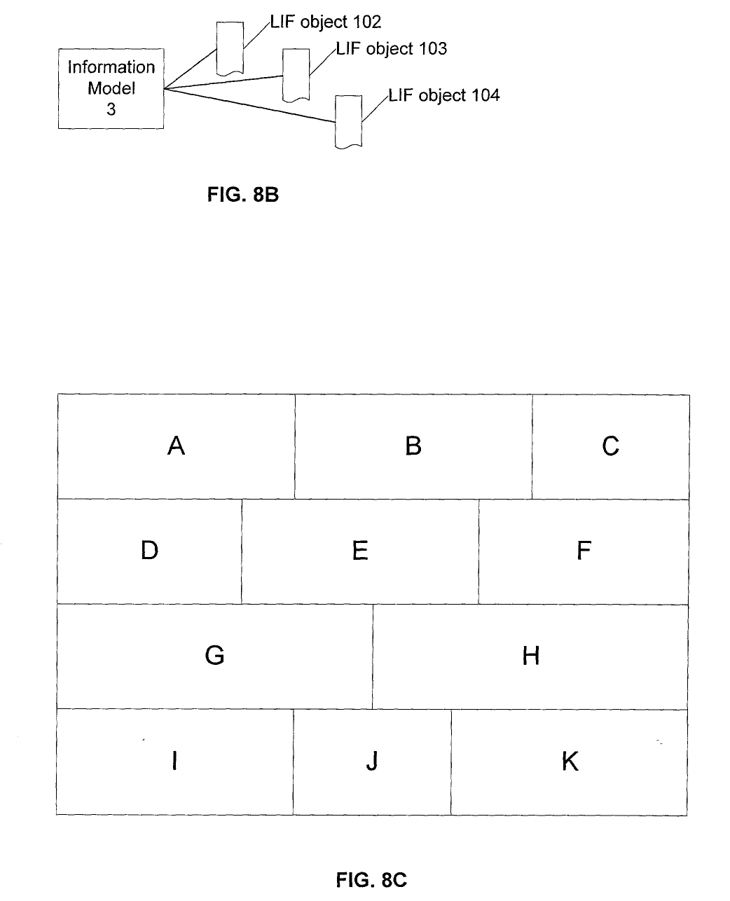

FIG. 8 is a block diagram illustrating an example database 48 in a system for manipulation of software. Database 48 can contain an information model such as information model 3. Additional information models can be stored in database 48. In one embodiment, database 48 may store the various information models in a file system hierarchy that includes directories, sub-directories, and related files. Alternatively, database 48 may store an information model, such as information model 3, in a more traditional database format using records with indices and the like. A variety of other data storage methods and techniques may also be employed by database 48, as will be evident to one having skill in the art.

FIG. 8A is a block diagram illustrating an example information model 3 according to an embodiment of the present invention. Information model 3 may be comprised of a plurality of LIF objects such as LIF 96A-C. Preferably, each LIF correlates directly to a discrete component of the information model 3. Furthermore, each LIF is preferably associated with one or more LDF files that represent, in language dependent format, the control and data dependencies of the native source code in addition to other source code data that enriches the information model 3. For example, certain information from the source code files, such as structural information and programmer commentary may reside in documentation files that support information model 3.

The documentation files, or templates, are preferably associated with the various LIF objects that comprise information model 3. For example, LIF 96A may have several associated documentation files such as template 98A, template 98B, and template 98C. Similarly, LIF 96B may have several associated documentation files, namely template 98D, template 98E, and template 98F. Also, LIF 96C may have several associated documentation files—template 98G, template 98H, and template 98I. The documentation templates preferably contain information related to the component/LIF they are associated with and can be broken down according to the structural design of the particular component. Advantageously, this allows for the structural detail of each component to be separately documented, thus increasing the benefits provided by the whole system.

The various documentation files can also be collected together in the file system hierarchy or database for more efficient storage. Alternatively, each documentation template file may be stored together with the LIF object that it supports. Advantageously, the documentation template files may be stored in a compressed format to maximize storage space.

FIG. 8B is a block diagram illustrating an example information model 3 with supporting derivative LIF objects 102, 103, and 104, according to an embodiment of the present invention. Information model 3 preferably is composed of a plurality of LIF objects (not shown) and associated documentation templates (not shown). Each LIF object corresponds to a component in the information model.

In one embodiment, the hierarchical organization of the components can be modified and enhanced by the system architect in order to create a new view of the information model. Preferably, each new view of the information model can be persistently stored in a database (not shown) as a derivative LIF object. A single information model may have a plurality of discrete derivative LIF objects associated with it. For example, information model 3 may have derivative LIF object 102, derivative LIF object 103, and derivative LIF object 104.

Advantageously, each discrete derivative LIF object may contain meta data that describes the entire view of the information model. For example, derivative LIF object 102 may represent a design engineer's first organization of the information model, while derivative LIF object 103 may represent an updated, second organization. Similarly, the model design may be updated again and this third version of the information model may be stored in derivative LIF object 104. When viewing the information model, the model viewer preferably does not need to read any previous versions of derivative LIF objects to present the entire information model.

Additionally, derivative LIF objects preferably do not modify any LIF objects or component related data in the baseline information model. This allows each discrete derivative LIF object to contain the presentation meta data relating to the baseline information model, and therefore be independent of any intervening, or previous versions of derivative LIF objects. An additional advantage of using discrete, independent derivative LIF objects that contain presentation meta data for a baseline information model is that it provides the ability to return to previous versions or organizations of the information model. An additional advantage is that the baseline information model is never modified, thus preserving the native application representation. Alternatively, rather than creating a derivative LIF object, system architect 6 may create a derivative LIF object for the new, enhanced, or modified component.

Referring back to FIGS. 1 and 4, once information model 3 has been created, it can be used as input to a variety of tools and utilities that can be employed by design engineers. Such tools and utilities may include model viewer 4, model editor 5, system architect 6, document generator 7, difference generator 8, search engine 9, and stand alone generator 11.

For example, the components and other elements of information model 3 can be viewed through model viewer 4. Preferably, model viewer 4 can examine a derivative LIF object, such as X, Y, or Z, and present that particular derivative LIF object of information model 3. Advantageously, derivative LIF objects can be saved in persistent storage so that previous versions, or views, can be recalled by model viewer 4.

Information model viewer 4 provides a graphical presentation of the information model generated by the generator 2. The viewer 4 may present a visual diagram of the software architecture that is inherent in the body of source code. For example, viewer 4 may graphically represent the components derived from the body of source code by generator 2. Additionally, viewer 4 may graphically represent the relationship of each component to the other components in the software architecture. In one embodiment, the components that comprise the software architecture may be presented in a tiled view, as illustrated in FIG. 8C. The tiled components of the software architecture, A-K, are presented in a brick wall arrangement that shows the components relationship to each other.

In an alternative embodiment, the tiled components of a software architecture may be presented in an inscribed or cascading arrangement where the highest level component of the system may have several lower level components inscribed within its borders. Each of the lower level components may also have several sub-components inscribed to create an inscribed tiled view of the aggregate components that comprise the software architecture of the body of source code.

In addition to graphically presenting a view of the components of the software architecture, viewer 4 may also graphically portray the control and data dependencies in the system. A control flow or functional dependency may exist between components when a program fragment from a first component transfers program control to a program fragment in a second component. In one embodiment, such transfer of program control may be achieved via function calls. Similarly, a data dependency may exist between components when data defined in a first component is referred (i.e. used or modified) in a second component.

In one embodiment, the control and data dependencies may be provided on a component by component basis. For example, a directed line between two components may portray the control dependencies of a component. Advantageously, viewer 4 may graphically present the control and data dependencies between all of the components that are displayed in the tiled view of the software architecture. Furthermore, the graphic presentation may employ various colors of directed lines to designate attributes of the dependencies.

Additionally, the data dependencies of a component may be depicted by a directed line between two components. In one embodiment, a directed line between two components may be used to indicate which component is the source of the data and which component uses the data. Alternatively, a data browser may be provided that displays and details the data elements passed between components. In one embodiment, a data browser is a user interface that allows a user to navigate through and view the contents of data objects such as the type, the initial value, the operators available to that type, and other contents germane to a data object.

In one embodiment, viewer 4 preferably allows an information model to be browsed from the macro level to the micro level. For example, upon initiation of viewer 4 and designation of an information model, viewer 4 may present a macro view of the information model. The macro view may provide a tiled view of the highest level components. In one embodiment, the macro view may consist of a single component. Alternatively, the macro view may present the highest level components along with sub-components tiled within the borders of the highest level component or placed subjacent thereto. Additionally, control and data dependencies may be indicated between the components. For example, directed lines and colored directed lines may be used to indicate a control or data dependency between two components.

Viewer 4 may accept input from a user selecting a particular desired component. Upon selection, viewer 4 may drill down into a more granular presentation of the selected component. For example, when a component is selected, viewer 4 may present the sub-components of that component and all of the control and data dependencies of those sub-components. In this fashion, the information model can be browsed down to the most granular sub-component.

Upon selection of a component that does not have sub-components, viewer 4 may include a component view that presents each function call contained in the component that calls a function that is defined outside of the component. For example, a component's dependency list contains each foreign component that contains a function that is called from within the component. Additionally, control dependencies may be presented through a component view such that each incoming function call from a foreign component is represented by a directed line that indicates the particular function being called and the particular foreign component that made the call.

Alternatively, viewer 4 may provide a calling tree viewer (not shown) that presents the dependency relationships between each of the functions that are contained within a single component and also dependencies on functions that are not defined within the scope of the component under investigation. For example, a component may have several function calls that reference functions that are native to the component. A calling tree view preferably provides the ability to navigate the sequence of function calls that are native to a component. In one embodiment, viewer 4 can provide a seamless transition between browsing through the external foreign function calls and the native internal function calls.

Furthermore, viewer 4 may also present information relating to the components or functions within a component. In one embodiment, viewer 4 may present documentation that describes and supports components and functions. For example, a certain component may have an interface comprised of each call-in function contained in the component. This interface may be described in a documentation file and presented by viewer 4 upon request.

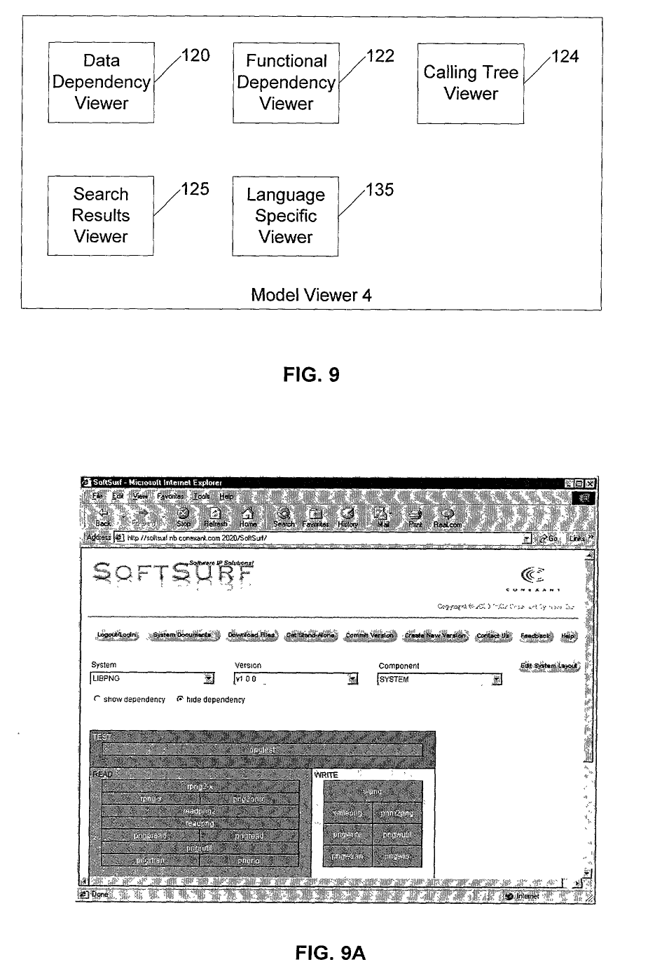

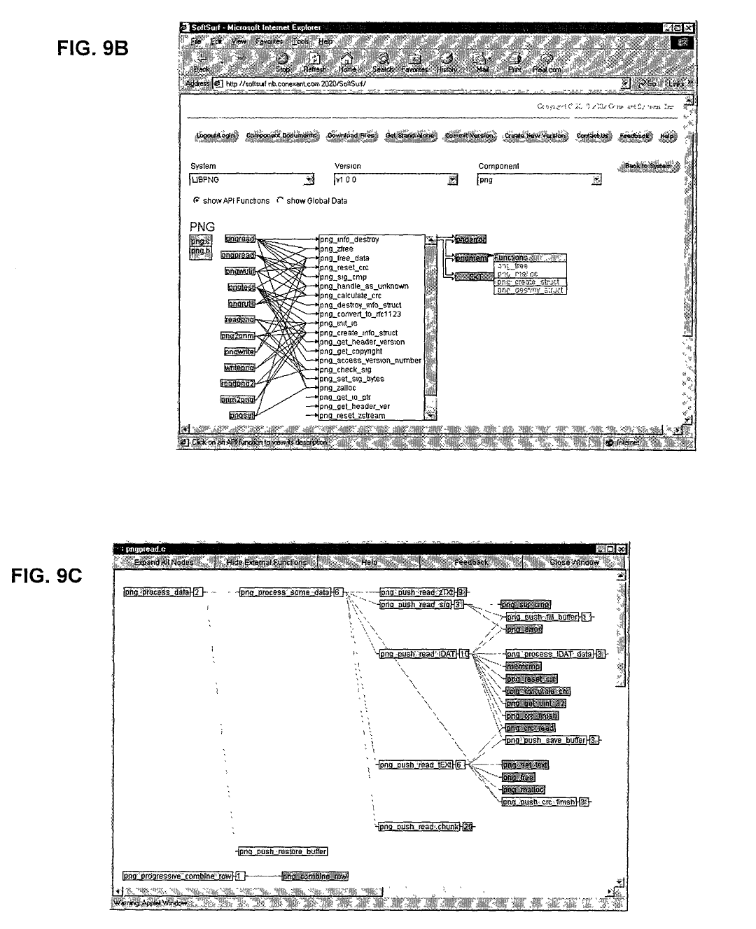

FIG. 9 is a block diagram illustrating an example information model viewer 4 in a system for manipulation of software. Viewer 4 may be comprised of a data dependency viewer 120, a functional dependency viewer 122, a calling tree viewer 124, a search results viewer 125, and a language specific viewer 135. Each of these components are preferably seamlessly integrated into viewer 4 such that the transitions between browsing data dependencies to browsing control dependencies to browsing search results to browsing model comparisons are fluid.

In one embodiment, the model viewer 4 may present a visual diagram of the software architecture inherent in the body of source code. For example, the model viewer 4 may display the highest level components of the information model, portraying any lower level components in a cascading tile fashion. Additionally, selection of a particular component preferably causes the model viewer 4 to display the contents of that component, including the sub-components and any files contained therein. Preferably, model viewer 4 allows for the seamless transition between different views of the information model when browsing the model.

FIG. 9A is a software application window illustrating an example model viewer 4 according to one embodiment of the present invention.

In one embodiment, the data dependency viewer 120 presents the data dependencies between components of the information model. Data dependencies may be displayed by data dependency viewer 120 as directional lines or edges between two components. Additionally, data dependencies may be displayed by data dependency viewer 120 as a directed line between a component and a particular function within a component. Also, color can be used in combination with the directed line to further identify and distinguish the dependency.

In an alternative embodiment, data dependency viewer 120 may portray the data dependencies between individual functions. For example, data dependency viewer 120 may display the data passed in a particular function call. Advantageously, this provides an interactive view of the structure of the data. Also, color can be used in combination with the directed line to further identify and distinguish the dependency.

Functional dependency viewer 122 preferably presents the control dependencies within the information model. Control dependencies can be at the system level or the component level. Control dependencies at the system level preferably include the dependencies between components. Control dependencies at the component level preferably include the dependencies that exist within a particular component.

For example, a first component that relies on the functions contained within a second component can be described as having a system level functional dependency on the second component. Alternatively a first function within a component that calls a second function within the same component can be described as having a component level functional dependency on the second function.

In one embodiment, control dependencies can be displayed by functional dependency viewer 122 as a directed line or edge. Preferably, the directed line or edge travels from the first function or component to the second function or component, indicating the dependency. For example, the line traveling between the two components may include a directional arrow to indicate the dependent component. Alternatively, color can be used in combination with the directed line to further identify and distinguish the dependency.

FIG. 9B is a software application window illustrating an example component viewer according to one embodiment of the present invention. Preferably, the component viewer may comprise data dependency viewer 120 and functional dependency viewer 122.

Calling tree viewer 124 preferably presents a limited set of the control flow and functional dependencies within a component. For example, calling tree viewer 124 may initially present all top level functions within a component. A top level function is a function that is not called by any other program fragment within that component, although it may be called by program fragments from other components. Each function called within the body of a top level function is presented as a function at the next lower level. This depiction can preferably be recursively applied to all top level and lower level functions within a component. Functions that are at the lowest level are either functions in a component that do not call any other function (“terminal functions”), or functions defined in other components and whose control flows are not viewable in the context of the current component (“external functions” or, equivalently, “external control dependencies”).

FIG. 9C is a software application window illustrating an example calling tree viewer 124 according to one embodiment of the present invention.

Search results viewer 125 preferably displays the results of any search conducted by the information model search engine. In one embodiment, the results from different types of searched may be presented in different formats. For example, a search for a data type may be presented in a text view with a description of the data type. Similarly, a function definition may also be presented in a text view. Alternatively, the results of a query for a particular component may be better suited for display in a calling tree fashion so that the context of the component is delivered as part of the search results. For example, the search results may present a trace back from the search result (component) to the root component.

Language specific viewer 135 preferably provides language specific representations of the information model. The LIF objects comprising an information model contain information that enables their contents to be flexibly interpreted and presented in a manner and form conforming to a variety of different programming principles. Examples of various programming principles are procedural programming language principles, object oriented programming principles, data flow programming principles, logic programming principles, and the like. Although the native source code for an information model may conform to a particular programming paradigm, the contents of the LIF objects enable their interpretation and presentation according to a projected organization under a different programming paradigm.

For example, native source code in a procedural programming language such as COBOL, FORTRAN, Pascal, Java, or C could be presented according to a projected organization of the procedural programming language source code in an object oriented programming paradigm. This object oriented presentation would be more intuitively comprehended by designers developing their software designs in an object oriented framework such as the C++ or Smalltalk language. Advantageously a person having ordinary skill in the art may develop a language specific viewer for a desired language because the syntax and semantics of LIF objects are language independent.

Furthermore, an overall advantage of providing through viewer 4 a visual presentation of the software architecture inherent in an information model is the naturally resulting comprehension and understanding of legacy source code by design engineers. Visual presentation of the data and control dependencies of the legacy source code in an easy to understand format significantly increases the level of comprehension of the functionality of the underlying source code, which may be in a language unfamiliar to the modern design engineer or programmer.

Referring back to FIG. 4, model editor 5 can be used by design engineers to modify documentation templates A, B, and C. Advantageously, model editor 5 may allow the structural elements of a particular component to be described.

The information model editor 5 preferably allows for the editing of the previously described documentation files associated with each LIF object that comprises the information model. In one embodiment, documentation templates associated with an LIF object may describe one or more source code files associated with the LIF object and their various internal structural elements such as functions, data structures, global variables, etc. Additionally, a documentation template can describe the components, interfaces, and other aspects of an information model. For example, a set of incoming function calls that belong to a particular component may comprise the interface for that component. Accordingly, a document preferably exists that describes the interface for the component. Editor 5 may provide that document for viewing and allow that document to be edited while being viewed. Additionally, editor 5 may also accept a replacement file for that document, thus allowing for efficient updates to large documentation files.

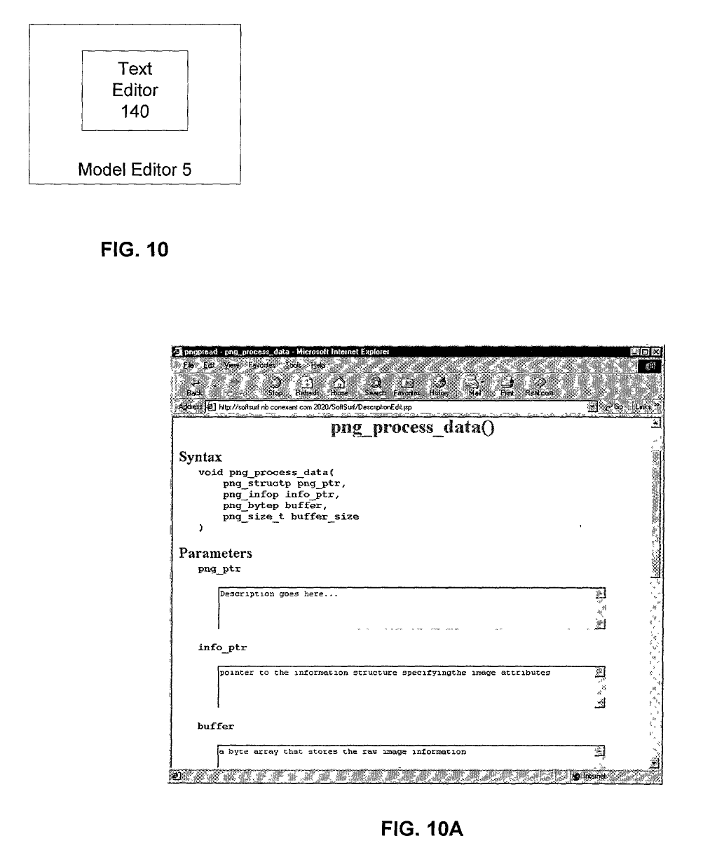

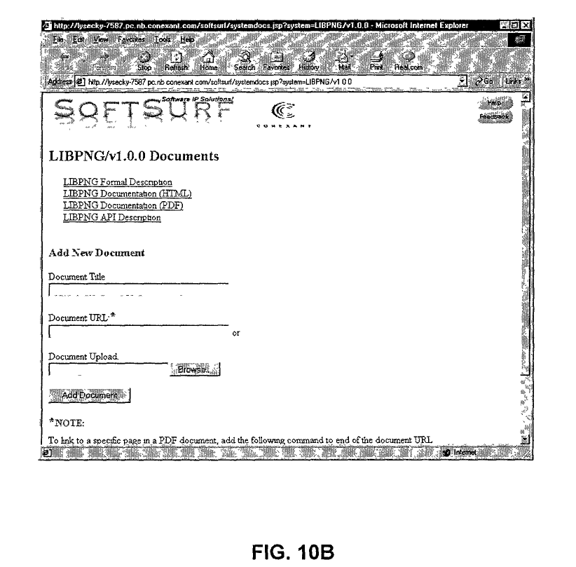

FIG. 10 is a block diagram illustrating an example information model editor 5 in a system for manipulation of software. The model editor 5 preferably performs the function of displaying documentation associated with the elements of the information model. Additionally, the model editor 5 preferably performs the function of receiving and saving edits to the documentation.

In one embodiment, the documentation data may be integrated with the information model. Alternatively, documentation data may exist in separate files that are stored in a database along with the information model and the body of source code.

Model editor 5 may be comprised of a text editor 140. Text editor 140 can be used for editing the text of documentation while the documentation is being displayed. For example, a documentation template file that is associated with a particular component's interface may be displayed through text editor 140. The data in the documentation file may be modified through text editor 140 while the documentation is being displayed. Subsequently, text editor 140 may save the documentation file, including any new edits, to a location that houses documentation files that are associated with the information model.

FIG. 10A is a software application window illustrating an example model editor 5 according to one embodiment of the present invention.

In an alternative embodiment, editor 5 may be equipped with a file interface (not shown) that provides file transfer capability. Such a capability may allow documentation templates to be downloaded for offline editing on a local computer. Additionally, a file interface may allow new or existing documentation templates to be uploaded and incorporated with the other documentation templates that are associated with the LIF objects of the information model.

For example, a file interface may be used to receive an entire documentation file. Advantageously, the file interface may allow a documentation file to be downloaded and edited offline and subsequently returned to the server through the file interface. The file interface preferably saves any documentation files received to the same location that houses the other documentation files associated with the information model.

For example, a documentation file may be created anew or modified from a previous version and stored in a local storage area, for example on a disk drive attached to a computer. Subsequently, a design engineer or user can establish a connection from the local computer to the server computer. Once connected, the user may upload the documentation file, thereby merging it with the rest of the documentation contained within the information model. Preferably, the upload process gathers information relating to the particular documentation file's association with the information model.

FIG. 10B is a software application window illustrating an example document linking and upload utility according to one embodiment of the present invention.

Referring back to FIG. 4, design engineers may use system architect 6 to create additional derivative LIF objects of information model 3. For example, design engineers may use system architect 6 to rearrange the components of information model 3. Additionally, design engineers may use system architect 6 to enhance information model 3 by adding a completely new component. Furthermore, design engineers may use system architect 6 to create an entirely new information model that has no underlying LIF objects, LDF files, or source code files. Finally, design engineers may use system architect 6 to derive a particularly desirable subset of functionality from information model 3.

The system architect 6 preferably allows design engineers to modify, enhance, and optimize an information model. For example, a design engineer may use system architect 6 to rearrange the component blocks of an information model or combine the existing components into a larger component. Additionally, a design engineer may use system architect 6 to enhance an information model by adding a new component. The new component can be integrated with the rest of the components that comprise the information model to extend the functionality of the application. The rearranged or enhanced information model can advantageously be saved as a derivative LIF objects of the underlying baseline information model.

In one embodiment, system architect 6 may also allow a design engineer to create a new information model from scratch. For example, a design engineer may begin with nothing and create several new blocks as components. These components can be created and arranged using system architect 6 until the desired configuration for the application is achieved. A newly created information model may advantageously be saved as a derivative LIF object that has no underlying baseline structure, or no underlying LIF objects.

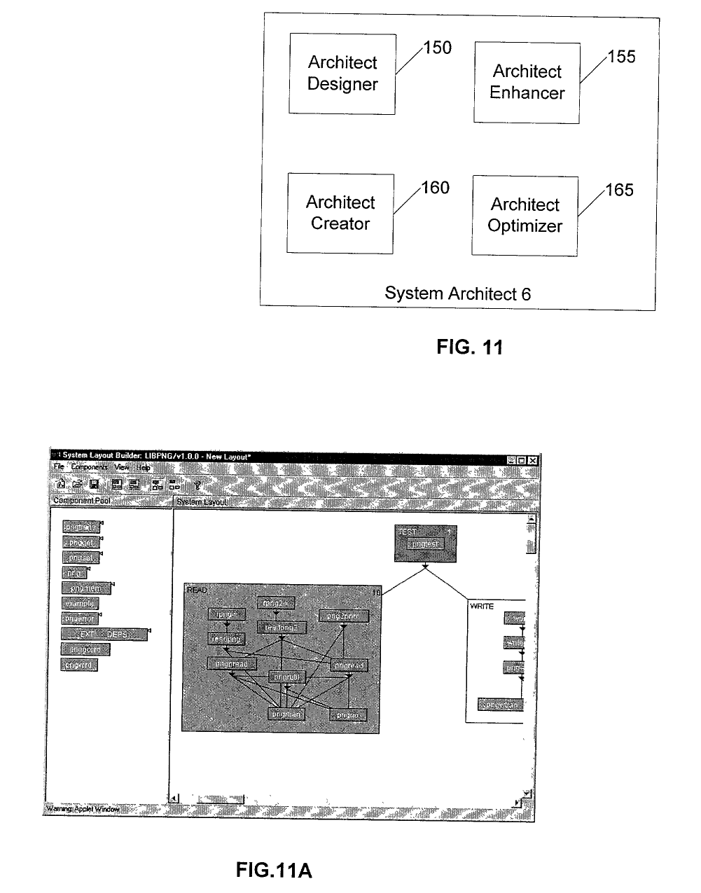

FIG. 11 is a block diagram illustrating an example system architect 6 in a system for manipulation of software. Preferably, the system architect 6 can perform the functions of reorganizing the components of an information model, adding a new component to an information model, optimizing the component set in an information model, and creating an entirely new information model.

System architect 6 may be comprised of an architect designer 150 for reorganizing the components of an information model, an architect enhancer 155 for adding a new component to an information model, an architect creator 160 for creating an entirely new information model, and an architect optimizer 165 for paring down the components of an information model into an optimized set of components. The system architect enables rapid architectural reorganization and creation by providing color coded symbols that dynamically indicate dependencies between the raw components (e.g. those that have not yet been included in an architecture) and the components in the existing architecture.

In one embodiment, system architect 6 produces a new derivative LIF object of an information model. For example, a design engineer may use system architect 6 to rearrange the components of an information model or add a new component to the information model. The result of the design engineers work is preferably a derivative LIF object that contains meta data describing how the structure and characteristics of the information model are to be presented. Advantageously, each new derivative LIF object contains all of the necessary information to present the components of the baseline information model in the desired structural organization.

The architect designer 150 preferably allows a design engineer to rearrange, merge, and group the components of a system model. For example, components can be merged together to create a larger component. Furthermore, a merged component may be broken down into constituent sub-components. The component grouping feature supports the creation of hierarchical component groups (e.g., a group within a group within a group.) Additionally, component groups may be enriched with text and colors to convey a better sense of organization. The architect designer 150 dynamically presents dependency hints between components and component groups, and guiding engineers in creating meaningful, layered architectural layouts.

FIG. 11A is a software application window illustrating an example system architect designer 150 according to one embodiment of the present invention.

The architect enhancer 155 preferably allows a design engineer to extend the architecture of the information model by creating a new component that is included with the existing components of the information model. For example, a design engineer may use architect enhancer 155 to create a new block as a component in the information model and assign that block a certain place within the component hierarchy of the information model. The new component may also be designed with an interface of functions that are available to other components. Similarly, the new component may be designed with a set of outgoing function calls that provide control dependencies and additional data dependencies to the component.

Advantageously, once the new component has been designed, architect enhancer 155 can create a new LIF object for the newly created component. Furthermore, documentation templates can also be created and associated with the LIF object to provide information pertaining to the structures within the component. Preferably, the new LIF object is seamlessly integrated into the new derivative LIF object that is created. A difference between the new LIF object and other LIF objects is that the new LIF object may not have an underlying LDF files associated with it. Additionally, the new LIF object may not have any underlying source code files associated with it.

Architect creator 160 is preferably used to create an entirely new information model. For example, a design engineer may begin with a blank or empty information model and create a new block and assign it status as a component. Similarly, the design engineer may create a plurality of additional components and provide a hierarchical structure for the newly created components. A designer may further refine his component based design by specifying the input and output characteristics of the interface for a component (“application programming interface” or “API”). These APIs are a specification of the control and data dependencies imposed on the LIF associated with the component.

Advantageously, once the new components have been designed and the structure and dependencies have been indicated, architect creator 160 can create a plurality of new LIF objects, one for each of the newly created components. The system architect preferably can create—from the APIs and other component based artifacts—documentation templates that are associated with each LIF object and which can be populated to provide additional documentation to describe the newly created components.

Preferably, a derivative LIF object is created for the newly created information model. This new derivative LIF object, however, is not a derivative of an existing information model. Rather, the baseline information model is comprised of the newly created LIF objects. The difference between an information model newly created through architect creator 160 and an information model created through the model generator is that the former information model does not, implicitly, have any underlying LDF file or source code files associated with it.

Once the designer creates a new architecture “A” (or extends an existing architecture) using the architecture creator 160, the architecture creator 160 can preferably create a reference design “R” as a source code template. Advantageously, the reference design “R”, when processed by the parser 52 (FIG. 5A) and the composer 56 (FIG. 6A) will re-generate architecture “A”. By populating the source code template (of reference design “R”) with source code fragments that let the design meet its functional requirements, design engineers and developers can rapidly create new applications.

Architect optimizer 165 preferably determines the minimal components, files, and functions within an information model that comprise the pared down, streamlined, optimized set of required components, files, and functions that provide the requested functionality. For example, a native application may have several hundreds of thousands of lines of code. The native application may perform multiple functions, only one of which is desired by a design engineer.

In one embodiment, architect optimizer 165 can analyze the information model and determine which components, files, and functions are required for the desired functionality. Subsequently, a new information model can be created that advantageously contains only those required components, files, and functions. For example, architect optimizer 165 may use commonly used techniques in the industry, such as threading and program slicing, to extract program fragments conforming to the control dependencies and data dependencies that exhibit the desired functionality. By following the thread (or threads) associated with the desired functionality, architect optimizer 165 can determine the necessary components, files, and functions that are to be included in the optimized information model.

In an alternative embodiment, architect optimizer 165 can be used in conjunction with architect enhancer 155 in order to create a streamlined information model containing the desired functionality and then enhancing that functionality with components representing new features.

In one embodiment, system architect 6 may also include a text editor (not shown) and a file interface (not shown). Similar to the information model editor, a text editor included with system architect 6 may facilitate the editing of certain files that are associated with the information model. For example, a text editor included with system architect 6 may allow a design engineer to edit the actual native source code files that comprise the software program. The modified source code files may then be processed by the information model regenerator utility in order to enhance or update the information model.

Furthermore, a file upload/download interface may allow certain files associated with an information model to be downloaded by a design engineer for offline editing or uploaded to the server for integration with the information model. Similar to the information model editor, for example, a file interface associated with system architect 6 may facilitate the offline creation of new source code files or offline modification of existing source code files.

In one embodiment a file interface can allow source code files to be downloaded by a design engineer for offline modification. Once the editing task is complete, the file interface can allow the modified source code file to be uploaded back to the server. Additionally, entirely new source code files can be uploaded to the server for inclusion with the body of source code that comprises the information model. Preferably, any new or updated source code files can be processed by the information model regenerator utility such that the new or modified functionality is included in the information model.

Referring back to FIG. 4, document generator 7 may generate a comprehensive set of documentation files associated with information model 3. Such a set of documentation will preferably help designers better describe their designs (i.e. source code) and enable faster, better comprehension that will foster reuse by other designers. Alternatively, document generator 7 may provide a comprehensive set of documentation files for a particular component or a particular functional thread within information model 3. Furthermore, document generator 7 may generate and provide documentation pertaining to the entire information model.

Document generator 7 preferably can collate the individual documentation template files into a comprehensive set of documentation for a particular information model. Advantageously the comprehensive documentation can describe the components, functions, interfaces, and features of the software application that is represented by the information model.

Referring back to FIG. 4, difference generator 8 preferably analyzes two or more information models and determines the differences between the models. For example, a design engineer may desire to know the differences between two derivative LIF objects of the same information model. Alternatively, a design engineer may desire to know the differences between completely different information models.

In one embodiment, difference generator 8 may generate a difference set, or a difference information model (“DIM”) that comprises the differences between the information models that were analyzed. Advantageously, the differences between the two or more models that were analyzed can be presented at a component level or at a function by function level, depending on the magnitude of the differences. Additionally, the differences may be presented at both a component level and a function level, when both significant and minor differences exist.

Referring back to FIG. 4, design engineers may also employ model search engine 9 to search through information model 3 for desirable information. Additionally, model search engine 9 can limit a search to a particular component or some other subset of information model 3. Furthermore, model search engine 9 may allow design engineers to conduct searches across multiple information models, or in a particular component that exists in multiple information models.

The information model search engine 9 preferably accepts and responds to search queries. The search engine 9 may search for a response to the query in a single information model, multiple information models, ancillary database files, supporting documentation files, related data files, or other files that are germane to the system, the user, or the information model or models.

For example, the search engine 9 can search a plurality of information models or a particular information model. Additionally, search engine 9 can search a particular component within an information model, or a particular set of components in an information model. Furthermore, search engine 9 may search a set of related components that reside in a plurality of information models. Advantageously, the type of search conducted, or the scope of the search conducted may be provided as variable input to search engine 9, thus allowing search engine 9 to search for defined items across a variety of information models, components, or related files.

In one embodiment, certain information may be maintained in a searchable database (not shown) that is accessible by search engine 9. The information in the searchable database may advantageously be automatically populated into the database by the different modules that comprise the system 10. For example, generator 2, viewer 4, editor 5, and system architect 6 may each be configured to store in the database information related to their various functions.

Referring back to FIG. 4, stand alone generator 11 may be used to create an information model browser tailored to a specific body of source code. In one embodiment, the stand alone generator can selectively enable/disable features in the information model browser. Such a stand alone system may be comprised of an information model 3 and a model viewer 4. Additionally, model search engine 9 may or may not be present in a stand alone system. Advantageously, such a system may provide a group of design engineers the ability to comprehend the body of source code that information model 3 is derived from.

Referring back to FIG. 4, design engineers may employ a template creation utility (not shown) that creates a template with code definition blocks that correspond to the structural elements of each component in information model 3. Additionally, a template population utility (not shown) may be provided that allows a design engineer to edit the template and directly input action source code that would make the template a working native source code file. Additionally, a design engineer may be able to upload source code files for inclusion with the template.

Furthermore, in one embodiment, a design engineer may use a translation utility (not shown) to translate the native source code into the desired language and populate the template with the translated code. Alternatively, a source code generation utility (not shown) may be provided that creates source code from a sufficiently detailed outline and populates the generated source code into the template. Furthermore, once the template(s) have been populated, the resulting native source code files may be processed by the incremental generator 58 (described with reference to FIG. 7) to create a new information model 3.

In an alternative embodiment, a portal for information models may be provided. Such a portal (not shown) may advantageously present information models or components of information models for review by interested parties. Additionally, access to the viewing of information models may be provided over a public network, thus drastically increasing the potential customer base for the portal. For example, interested parties may be allowed to browse through a component using a publicly available version of model viewer 4. In this fashion, interested parties may determine if the component contains the required attributes and whether they desire to acquire the component or entire information model as software intellectual property (“IP”).

An information model portal may also provide component or information model distribution over a network (not shown). Advantageously, this may allow the IP being offered through the portal to be purchased and delivered without any significant overhead on the part of the IP owner. Alternatively, the IP component may be delivered to the purchaser over the network, but from a separate, protected site. This may advantageously allow the owner of the IP to keep the actual components or information models protected at a secured location while taking advantage of the public network as a distribution tool only.

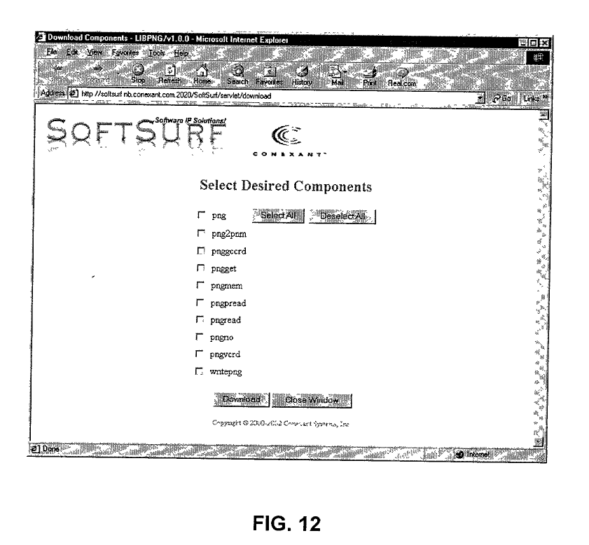

FIG. 12 is a software application window illustrating an example component download utility according to an information model portal embodiment of the present invention.

In one embodiment, the system may be employed as an IP repository. For example, the system may be used internally within a corporation to organize and maintain the company's IP. Advantageously, such a system may prevent redundant storage and also provide the company's design engineers access to the company's IP. This may result in the reuse of IP that would otherwise have been recreated. Alternatively, a freeware association or an open systems association may maintain an external, public IP repository. Such a repository may allow access to the IP for anyone with a public network connection and the desire to view the IP.

In an alternative embodiment, the system may be used as a training aid for design engineers. For example, document generator 7 may generate dynamic documentation of the various components that comprise information model 3. Alternatively, dynamic content may be generated that allows design engineers to develop and process certain usage cases for the targeted application or underlying source code 1. For example, a training aid module (not shown) may walk a design engineer through the steps for building a new application on the top of some acquired source code 1.

In such an embodiment, the acquired source code 1 may be generated into information model 3. The training aid may then present the information model to the design engineer and employ system architect 6 to walk the design engineer through the steps required to enhance the information model with a new component. In this way, the design engineer may learn how to use system architect 6 while also gaining valuable knowledge about how the underlying acquired source code 1 is organized.

In yet another alternative embodiment, model editor 5, system architect 6, or a source code editor (not shown) may receive new source code to provide an underlying structure to a newly created or enhanced information model 3. For example, in a development environment, an information model 3 may be created to provide a visual presentation of an incomplete development project. Such an information model 3 may be based on the current (and incomplete) set of source code 1. Subsequently, new source code may be added to the work in progress through model editor 5, system architect 6, or the source code editor. Thereafter, a new information model 3 can be created that includes the new source code, as added through model editor 5, system architect 6, or the source code editor.

In one embodiment, new source code may be added through the editing of existing source code files. For example, model editor 5, system architect 6, or the source code editor may present an existing source code file to a design engineer who edits the file and incorporates the new code. When the edits are complete, model editor 5, system architect 6, or the source code editor can then save the source code file containing the new code. Preferably, some form of a notification trigger (an email, a OS level flag, a timer interrupt, a signal to a continuously executing OS task in the background, etc.) is enabled to indicate that one or more source code files have been modified.

Alternatively, model editor 5, system architect 6, or the source code editor may accept new source code through the receipt of a new file. Upon receipt of the new file, model editor 5 or system architect 6 may store the new source code file along with the other source code files that comprise the source code 1. Preferably, the new source code file is received with structural information describing the location for the new source code file within the component hierarchy of information model 3. Furthermore, a flag or other indicator is preferably set to indicate that the particular source code file has been added to source code 1.

An additional way to receive new source code may be for model editor 5 or system architect 6 to receive a new version of a file that already exists. Upon receipt of the new version of the file, model editor 5 or system architect 6 may replace the older version of the file. Preferably, some form of a notification trigger (an email, a OS level flag, a timer interrupt, a signal to a continuously executing OS task in the background, etc.) is enabled to indicate that one or more source code files have been modified.

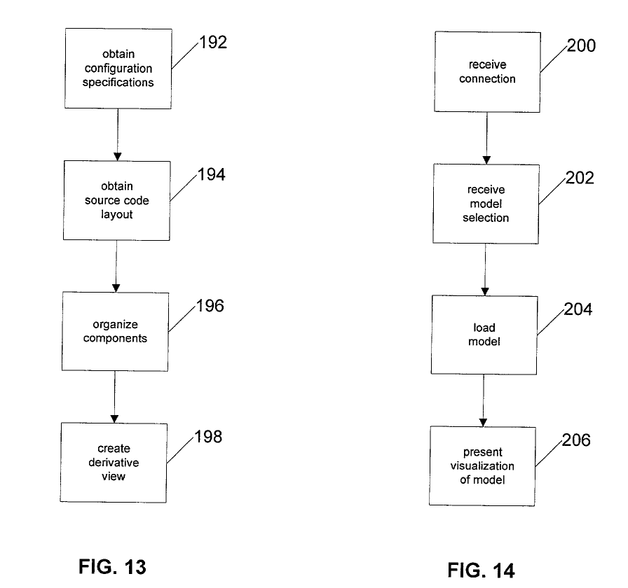

FIG. 13 is a flow chart illustrating an example process for organizing LIF objects into a derivative LIF object of an information model based on configuration specifications and structural information. Once all of the LDF files have been analyzed and the baseline LIF objects generated, as previously described with reference to FIG. 5A and FIG. 6A, the system may consult a set of configuration specifications to determine how the information model should be constructed, as indicated in step 192.

In one embodiment, the configuration specifications may be collected in a configuration file that preferably discloses how the information model should be constructed. For example, one option may be to create a component for each file and a component for each directory. Additionally, each file in a parent directory may be declared to be a sub-component of the component created for the parent directory. The resulting information model would thus have a component corresponding to each directory in the body of source code, and a sub-component corresponding to each file in the body of source code.

Furthermore, a configuration file may describe a naming convention for the various components of the information model. For example, each component name could be the same as the file or directory name to which it corresponds. Alternatively, certain configuration options or specifications, such as the names of components, may be requested by the system on an interactive, as needed basis.

An additional factor that may be considered by the system in organizing the information model is the structural hierarchy of the file system where the native source code files are stored. As described above, the file system hierarchy can be used to organize the components such that each file component is a sub-component of the component created for its parent directory. The source code layout can preferably be obtained by the system, as seen in step 194. This information may be provided to the composer by a structural analyzer or the composer may determine the layout itself.

Once the configuration specification have been obtained and the source code layout has been obtained, the components that comprise the information model can be organized, as illustrated in step 196. Organization of the components can be an automated process, as in the case where the components are structured to mirror the hierarchical file system structure of the raw body of source code. Additionally, organization of the components can be an interactive process that advantageously allows a software engineer to create components out of the various files, create larger components out of components, and dissolve components into their constituent files and or sub-components.

Once the organization of the components is complete, an initial derivative LIF object of the information model can be created, as shown in step 198. Advantageously, this automated organization may allow savvy design engineers to save time when creating information models by defining how the components of the information model should be initially organized.

FIG. 14 is a flow chart illustrating an example process for presenting an information model. Initially, the server receives a connection from a user, as illustrated in step 200. The connection may preferably be received via a communications network. In one embodiment, users can connect to the server using a browser that supports the world wide web (“WWW”) service and the hyper text transport protocol (“HTTP”). For example, Microsoft Internet Explorer® and Netscape Communicator® are two examples of commercial WWW browsers.

Furthermore, the connection can be accepted by the server with or without verifying the access permissions of the user. For example, in one embodiment, any user with access to a WWW browser and the network that supports the server computer may be able to connect to the server. In an alternative embodiment, each user that attempts to connect to the server may be required to provide a valid username and password combination before access to the server is granted.

Once the server has received a connection, the server can receive a selection for the desired information model, as shown in step 202. In one embodiment, a list of information models may be presented to the user upon connection so that a selection can be made. Alternatively, a user may browse or search through a file system or database of information models until the desired information model is located and selected. Furthermore, selection of an information model may require an additional valid username and password combination. In one embodiment, access to the server may be freely granted while access to the information models may require authorization. Advantageously, this may allow an entity to advertise the service and provide basic access while reserving the value added access to information models for authorized clients.

Once a particular information model has been selected, the server may load the information model, as seen in step 204. Loading the information model can include reading the entire information model in to memory. Additionally, loading the information model can include creating a lock file for the information model such that access to the particular information is denied to other users. In one embodiment, a lock file may prevent duplicative write access to the information model while allowing other users to have read access to the information model.

Alternatively, loading the information model can include accessing a database of information models and submitting a query for the requested information model. Upon receiving an affirmative response from the database that stores the information model, the model may be read into memory. Additionally, loading the information model may require that the server system access a remote system in order to read the information model. For example, the information model may be archived in permanent storage across the network in an optical disk farm for long term storage. In such a case, several queries and disk accesses may be required to ultimately load the information model.

Once the information model has been loaded, a visual presentation of the information model can be displayed, as illustrated in step 206. Preferably, the information model is presented on the display of the client computer that selected the particular information model. In one embodiment, the information model can be presented in a newly created window of the WWW browser utility being used. Advantageously, this may allow the user to select additional information models for contemporaneous viewing.

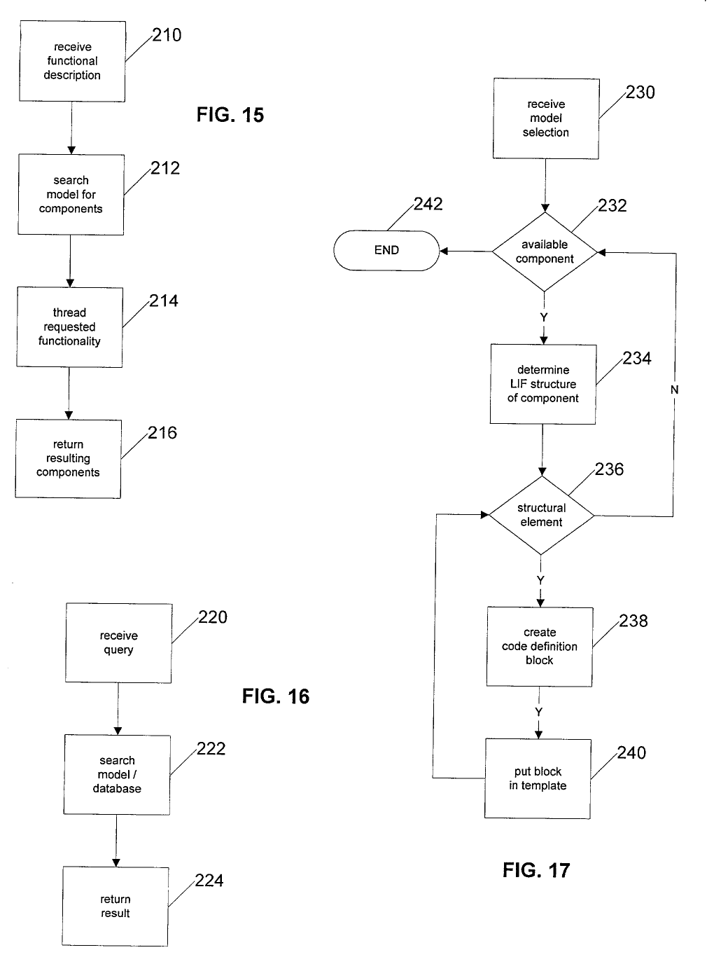

FIG. 15 is a flow chart illustrating an example process for optimizing an information model. Initially, in step 210 the system receives a description of the desired functionality. For example, the desired functionality may be contained within a particular component. Thus, the system would optimize the information model using the particular component as the baseline. Alternatively, the desired functionality may be described in terms of a query such as over component names, API names and contents (either control dependencies or data dependencies or both), etc.

Once the desired functionality has been defined, the system searches the information model for components, files, and functions that are related to the described functionality, as illustrated in step 212. For example, if the desired functionality is described as a particular component, the system may use a threading technique to search through the information model and determine every component, file, and function that is related to the particular component, as shown in step 214.

In step 216, the resulting set of components, files, and functions can be returned to the requesting design engineer. Advantageously, this optimization technique can allow a design engineer to quickly and easily cull the desired functionality out of an extremely large set of native source code files. Furthermore, the resulting optimized set of components, files, and functions can be saved by the system as a new information model. This new, streamlined, optimized information model may then be enhanced with the system architect to add new components and functionality to the optimized information model.

FIG. 16 is a flow chart illustrating an example process for searching an information model. Initially, the system preferably receives a query from a design engineer (the user), as shown in step 220. The query may be formulated in a variety of ways. In one embodiment, standard query language (“SQL”) may be used. Once the query is received, the system may search the information model for matches to the query, as seen in step 222.

Advantageously, the query processing system may search for results across a variety of information models. Alternatively, a query may be restricted to a particular information model. Furthermore, a query may be restricted to a particular component within an information model. Similarly, a query may be restricted to a particular component, but the particular component may exist in a plurality of information models. In such a case, the component in each information model may be searched. When the relevant source or sources have been searched, the results are preferably returned to the user, as illustrated in step 224.

FIG. 17 is a flow chart illustrating an example process for creating a template of an information model. Initially, in step 230 an information model is selected and the selection is received by the system. Once the model has been selected, the model is analyzed to determine if there is an available component, as shown in step 232. If a component is available, the component is analyzed to determine the structure of the underlying LIF object, as seen in step 234.

Advantageously, each LIF can be configured such that structural elements are well defined. Each structural element can preferably be associated with a related block of source code, or action code. In step 236, the system determines if there is a remaining structural element of the component in the LIF object. If there is a remaining structural element, a code definition block is created in the template file as a placeholder for the action code that corresponds to the structural element, as illustrated in steps 238 and 240.

Once the code definition block is placed in the template file, the system returns to step 236 to determine if there is a remaining structural element of the component in the LIF. If there is no remaining structural element of the component in the LIF object, the system returns to step 232 to determine if there is a remaining available component in the information model. If there is a remaining component, the process continues. If no component remains unprocessed, the creation of the template is complete, as indicated by step 242.

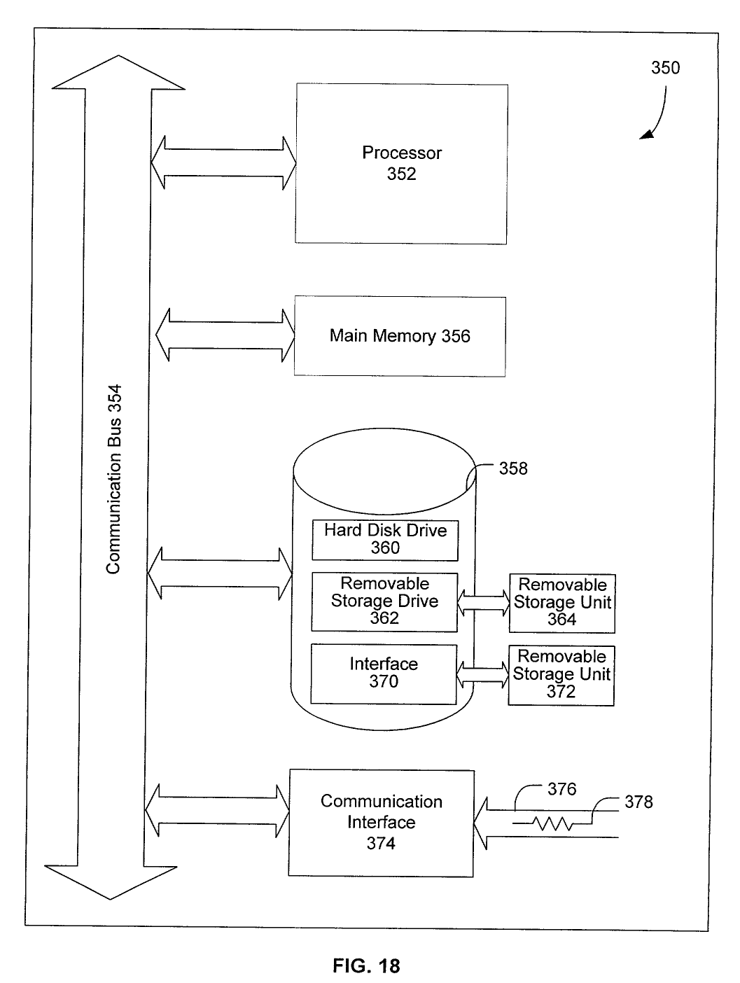

FIG. 18 is a block diagram illustrating an exemplary computer system 350 that may be used in connection with various embodiments described herein. For example, the computer system 350 may be used in conjunction with a client, an online transaction processor, a data warehouse, or to provide connectivity, data storage, and other features useful for operating an online transaction processor, a data warehouse, or a database management system. However, other computer systems and/or architectures may be used, as will be clear to those skilled in the art.

The computer system 350 preferably includes one or more processors, such as processor 352. Additional processors may be provided, such as an auxiliary processor to manage input/output, an auxiliary processor to perform floating point mathematical operations, a special-purpose microprocessor having an architecture suitable for fast execution of signal processing algorithms (“digital signal processor”), a slave processor subordinate to the main processing system (“back-end processor”), an additional microprocessor or controller for dual or multiple processor systems, or a coprocessor. Such auxiliary processors may be discrete processors or may be integrated with the processor 352.

The processor 352 is preferably connected to a communication bus 354. The communication bus 354 may include a data channel for facilitating information transfer between storage and other peripheral components of the computer system 350. The communication bus 354 further may provide a set of signals used for communication with the processor 352, including a data bus, address bus, and control bus (not shown). The communication bus 354 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

Computer system 350 preferably includes a main memory 356 and may also include a secondary memory 358. The main memory 356 provides storage of instructions and data for programs executing on the processor 352. The main memory 356 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, as well as read only memory (ROM).

The secondary memory 358 may optionally include a hard disk drive 360 and/or a removable storage drive 362, for example a floppy disk drive, a magnetic tape drive, an optical disk drive, etc. The removable storage drive 362 reads from and/or writes to a removable storage unit 364 in a well-known manner. Removable storage unit 364 may be, for example, a floppy disk, magnetic tape, optical disk, etc. which is read by and/or written to by removable storage drive 362. The removable storage unit 364 includes a computer usable storage medium having stored therein computer software and/or data.

In alternative embodiments, secondary memory 358 may include other similar means for allowing computer programs or other instructions to be loaded into the computer system 350. Such means may include, for example, a removable storage unit 372 and an interface 370. Examples of secondary memory 358 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage units 372 and interfaces 370, which allow software and data to be transferred from the removable storage unit 372 to the computer system 350.

Computer system 350 may also include a communication interface 374. The communication interface 374 allows software and data to be transferred between computer system 350 and external devices, networks or information sources. Examples of some types of components that might comprise communication interface 374 include a modern, a network interface (such as an Ethernet card), a communications port, a PCMCIA slot and card, and an infrared interface, to name a few. Communication interface 374 preferably implements industry promulgated protocol standards, such as Ethernet IEEE 802 standards, Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement non-standard interface protocols as well. Software and data transferred via communication interface 374 are generally in the form of signals 378 which may be electronic, electromagnetic, optical or other signals capable of being received by communication interface 374. These signals 378 are provided to communication interface 374 via a channel 376. This channel 376 carries signals 378 and can be implemented using wire or cable, fiber optics, a phone line, a cellular phone link, a radio frequency (RF) link, or other communications channels.

Computer programming instructions (i.e., computer programs or software) are stored in the main memory 356 and/or the secondary memory 358. Computer programs can also be received via communication interface 374. Such computer programs, when executed, enable the computer system 350 to perform the features relating to the present invention as discussed herein.

In this document, the term “computer program product”is used to refer to any media used to provide programming instructions to the computer system 350. Examples of these media include removable storage units 364 and 372, a hard disk installed in hard disk drive 360, and signals 378. These computer program products are means for providing programming instructions to the computer system 350.

In an embodiment that is implemented using software, the software may be stored in a computer program product and loaded into computer system 350 using hard drive 360, removable storage drive 362, interface 370 or communication interface 374. The software, when executed by the processor 352, may cause the processor 352 to perform the features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will be apparent those skilled in the relevant art. Various embodiments may also be implemented using a combination of both hardware and software.

1. Exemplary Embodiments

A. Language Dependent Format

An exemplary embodiment of a language dependent format will now be described in greater detail. It is understood that various other standard, custom, or proprietary language dependent formats may be employed as an intermediate format. Therefore, the following description of one example LDF is presented to enable one possible embodiment that is contemplated within the broad scope of the claimed invention.

In this exemplary embodiment, each discrete entity in a body of native source code (hereinafter “module”) may be analyzed and parsed into an abstract syntax tree. For the purposes of this example, a separate module represents each source code file in the body of native source code. Although commercial parsers provided by various vendors for the various programming languages may allow atomic modules to be aggregated into a larger module and analyzed as a single larger module, in this exemplary embodiment, each atomic module is separately analyzed and parsed, without first being combined into a larger module.

To create LDF files from a body of native source code, each module is analyzed by a parser to generate an abstract syntax tree that is stored as a persistent object. This persistent object is what can be referred to as an LDF file. Each LDF file preferably includes the information needed by the system for manipulation of software. For example, an LDF file may contain a list of all defined functions and called functions contained in the module, a list of all global variables referenced in the module, and a list of all user defined data types specified in the module.

When the parser analyzes a module, it advantageously recognizes explicitly defined and implicitly defined functions within the module. An explicitly defined function can be a procedural function definition in the module (as in a C procedural language module) or an object/class member function definition (as in a C++ object oriented language module). An implicitly defined function may include the various inherent functions provided by a programming language as a pre-existing library, for example the print f statement in the C programming language or the operator<< statement in the C++ programming language.

Additionally, when the parser analyzes a module it advantageously recognizes external functions that are called from within the module but are not necessarily defined in the module. As a result of analyzing each programming fragment in a module, the parser preferably inserts into the LDF file a list of function names comprising those functions contained within the module, including the explicitly and implicitly defined functions and any external functions called by the module.

Each explicitly defined and implicitly defined function named in the LDF file preferably includes additional information describing the characteristics of the function (hereinafter “function definition”). For example, the function definition may include a list of formal parameters and their type specifications, the return value type of the function, the optional program execution environment that will be passed to the function at execution time, the file name and line and column number at which the function call occurred in the source program, and all comments associated with the function.

The comments associated with a function can be presented in various ways within a source file. For example, one option is to insert comments that are associated with a function immediately preceding the definition of the function. Alternatively, meta-language elements such as Java document tags can be used to associate comments with the various syntactical units of a particular function definition.

Each function called by the module and named in the LDF file preferably describes the file name, line number, and column number in the source code module where the called function originated and a list of parameters that were passed to the called function.

Furthermore, each function named in the LDF file is uniquely named in the abstract syntax tree associated with the particular module. Advantageously, anonymous functions that are generated by the parser while parsing the original source code can be named uniquely by the parser.

Additionally included in the LDF file may be a list of all global namespace variables that have been referenced by executable portions of the module, a list of all variables in the global namespace that are defined in the source code file, the name of each variable, the location (source code file name, line and column number) where each variable is defined, and the type specification of each variable. References that modify the value of the variable are distinguished from references that do not modify the value of the variable. These global variables may be explicitly declared by the user or implicitly defined by the parser in the parsing process.

Also included in the LDF file may be a list of all user defined data types specified in the module. Such a list may preferably include aggregate data types such as struct, union (and any recursively defined combination of these), class, typedef, enum, and various others that are well known to those skilled in the art, just to name a few.

B. Language Independent Format

An exemplary embodiment of a language independent format will now be described in greater detail. It is understood that various other language independent formats may be employed. Furthermore, DTD specifications and XML may or may not be used in alternative embodiments with the various LIFs that may be employed. Therefore, the following description of one example LIF using DTD specifications and XML is presented to enable one possible embodiment that is contemplated within the broad scope of the claimed invention.

In this exemplary embodiment, each component of an information model is preferably specified as a language independent format (“LIF”) object. An LIF object can be a collection of valid extensible markup language (“XML”) documents conforming to a document type definition (“DTD”). The various XML documents that comprise an LIF object may conform to different DTDs. In a preferred embodiment, an LIF object may be stored as serialized objects in files.

It is understood that a person having ordinary skill in the art would be capable of creating an LIF object in XML that conforms to a specified DTD provided to that person. It is further understood that the general programming techniques available to those having ordinary skill in the art allow for the automation of the creation of LIF objects conforming to a specified DTD.

The content of each LIF object preferably includes the information that describes in detail the characteristics of a component. In this example, an LIF object can include: (1) the name of the component and a list of source files that comprise the component; (2) a list of function and data callouts from the component; (3) a list of function and data callins into the component; (4) a list of function and data APIs exported by the component; (5) a list of global and local data objects defined in the component; (6) a list of global and local data types defined in that component; (7) call graphs for each source code file (module) comprising the component; (8) a comprehensive call graph for the entire component; (9) a list of function prototypes for each function defined in the component; and (10) a top-level system organization and view of all the components.

Additionally, the content of an LIF file may also include:

1. Object Oriented Programming Artifacts

1.1. Classes and Objects

1.1.1. Abstraction, Implementation, Base classes

1.1.2. Constructors, Destructors,

1.1.3. Methods (Class vs Instance, Pure Virtual vs Virtual)

1.1.4. Data Objects (Class vs Instance)

1.2. Inheritances

1.2.1. Public, Private, Protected

1.2.2. Single, Multiple, Friend

1.3. Overloading (Function vs Operator)

1.4. Static vs Dynamic Polymorphism

2. Logic/Declarative Programming Artifacts

2.1. Inference Rules

2.2. Facts, Failures, Negations

2.3. Clauses (Horn, First Order, Discrete)

2.4. Operators (Arithmetic, Logical)

3. Object Design and Modeling

3.1. Encapsulation, Interfaces

3.2. Abstraction, Information Hiding, Localization

3.3. Derivation (Delegation, Generalization, Specialization)

3.4. Polymorphism (Early vs Late binding)

3.5. Messages

3.6. Simulation Events

3.7. Data Flows

3.8. Temporal Logic flows

4. Functional Programming Artifacts

4.1. Function Applicators, Functors

4.2. Bindings, Closures, Continuations

4.3. Lambda Definitions; and

4.4. Type specifications (definitions, expressions, operations).

Advantageously, all of the information included in an LIF object can be generated from the information found in the LDF file.

Furthermore, there is preferably a one-to-one relation between an LIF object and a component within the software architecture. Additionally, an LIF object is preferably synchronized with its underlying source code module. For example, the source code module is parsed into an LDF file which is in turn used to generate an LIF object. As long as the underlying source code is not modified, the LIF object, and therefore the component, remains an accurate description for the module. However, if the underlying source code is modified, a new LIF object may be generated to capture the modifications.

In this examplary embodiment, an LIF object corresponding to a component can be stored in a file system as a file or set of files in a sub-directory that is named the same as the name of the component. The name of the component is preferably determined by the information model generator. An alternative embodiment may associate an LIF object to a component name as a <key,values> pair, with the component name being the key and the LIF object being the values. Yet another alternative embodiment may create a single serialized file that stores all information available from all LIF objects. In summary, LIF objects can be associated with components in at least the above mentioned three different, alternative embodiments.

Furthermore, a component preferably consists of a set of files containing the source code. Such files may be categorized into varying subsets based on the programming language used in the source files. In this exemplary embodiment comprising an information model derived from a set of C language source files, the constituent files can be sub-categorized into source code files (such as files with names ending in “.cpp”, etc.) and header files (such as files with names ending in “.h”).

In this exemplary embodiment, the files constituting a component are preferably stored as XML documents conforming to the following DTD:

```
<?xml encoding=“ISO8859-1”?>
<!--
  The root document element is called files. This may be used as a
  mechanism to identify the kind of file being parsed and ensuring
  that the correct file has been generated.
  -->
<!--
  VALIDITY CONSTRAINT: Each line specifies exactly one file name.
  Filenames may optionally be relative, or with full path from root
  directory/folder.
  -->
<!ELEMENT files (#PCDATA)>
```

Furthermore, the system layout of an LIF object may capture certain aspects of a user defined system architecture built around the components in the LIF. For example, aspects captured may include: (1) a list of all components in the information model; and (2) a list of hierarchical groupings of components. Advantageously, the hierarchical groupings can preserve the boundaries of the elemental components forming the grouping. Also, each hierarchical grouping can have an associated attribute (either implicit or explicit) that indicates to an external system viewer how to display the element, for example with or without boundaries.

In this exemplary embodiment, the groups that are displayed with their elemental boundaries visible can be referred to as “component groups” while those that are displayed without the elemental boundaries can be referred to as “merged components.” Furthermore, each group may store other attributes that, for example, specify the display color of the group, the group name, and the display coordinates on a viewer, just to name a few.

In this exemplary embodiment, the system layout data preferably includes a complete list of all the attributes associated with components and groups and is preferably stored as XML documents conforming to the following DTD:

```
<?xml encoding=“ISO8859-1”?>
<!--
  The root document element is called SYSTEM. This may be used as a
  mechanism to identify the kind of file being parsed and ensuring
  that the correct file has been generated.
-->
<!--
  VALIDITY CONSTRAINT:
  Each system layout contains the VERSION, NAME, COMPONENT_POOL, and
  LAYOUT_POOL. The name for a system is the encoded name and
  version number for that system/version. Example: ATI/v1.0.0.
  Only one occurrence of a BLOCK with a given NAME element may exist
  within the entire hierarchy of the LAYOUT_POOL and COMPONENT_POOL.
  -->
<!ELEMENT SYSTEM (VERSION, NAME, COMPONENT_POOL?, LAYOUT_POOL?)>
<!--
  VALIDITY CONSTRAINT:
  The VERSION is the version number of the current format of the
  file. The NAME is the encoded string for the system's name and
  version number.
  -->
<!ELEMENT VERSION (#PCDATA)>
<!ELEMENT NAME (#PCDATA)>
<!--
  VALIDITY CONSTRAINT:
  Contains an unordered list of BLOCK's, GROUP's, and
  VIRTUAL_COMPONENT's.
  -->
<!ELEMENT COMPONENT_POOL ((BLOCK|GROUP|VIRTUAL_COMPONENT)*)>
<!--
  VALIDITY CONSTRAINT:
  Contains an unordered list of BLOCK's, GROUP's, and
  VIRTUAL_COMPONENT's.
  -->
<!ELEMENT LAYOUT_POOL ((BLOCK|GROUP|VIRTUAL_COMPONENT)*)>
<!--
  VALIDITY CONSTRAINT:
  A BLOCK is the graphical representation of a component within the
  system. However, this does not included virtual components.
  -->
<!ELEMENT BLOCK
  (NAME, X, Y, W, H, TW, TH, MIN_W, MIN_H, COLOR, TEXT_COLOR, STR_X,
STR_W)>
<!--
  VALIDITY CONSTRAINT:
  A GROUP may contain an unordered list of BLOCK's, GROUP's, and
  VIRTUAL_COMPONENT's. However, a group may be empty.
  -->
<!ELEMENT GROUP (X, Y, W, H, TW, TH, MIN_W, MIN_H, STR_X, STR_W,
    (BLOCK|GROUP|VIRTUAL_COMPONENT)*, SETTINGS) >
<!ELEMENT SETTINGS (TITLE, TEXT_COLOR, BACKGROUND_COLOR)>
<!--
  VALIDITY CONSTRAINT:
  A VIRTUAL_COMPONENT contains one or more BLOCK's.
  -->
<!ELEMENT VIRTUAL_COMPONENT
  (NAME, X, Y, W, H, TW, TH, MIN_W, MIN_H, COLOR, TEXT_COLOR, STR_X,
  STR_W, BLOCK+)>
<!ELEMENT TITLE (#PCDATA)>
<!--
  VALIDITY CONSTRAINT:
  Designates the x coordinate of the upper-left hand corner of a
  BLOCK, GROUP, or VIRTUAL_COMPONENT. Must be a positive integer.
  -->
<!ELEMENT X (#PCDATA)>
<!--
  VALIDITY CONSTRAINT:
  Designates the y coordinate of the upper-left hand corner of a
  BLOCK, GROUP, or VIRTUAL_COMPONENT. Must be a positive integer.
  -->
<!ELEMENT Y (#PCDATA)>
<!--
  VALIDITY CONSTRAINT:
  Designates the width in pixels of a BLOCK, GROUP, or
  VIRTUAL_COMPONENT. Must be a positive integer.
  -->
<!ELEMENT W (#PCDATA)>
<!--
  VALIDITY CONSTRAINT:
  Designates the height in pixels of a BLOCK, GROUP, or
  VIRTUAL_COMPONENT when viewed while showing dependencies. Must be
  a positive integer.
  -->
<!ELEMENT H (#PCDATA)>
<!--
  VALIDITY CONSTRAINT:
  Designates the width in pixels of a BLOCK, GROUP, or
  VIRTUAL_COMPONENT when viewed while dependencies are hidden(also
  referred to as, Tiled View). Must be a positive integer.
  -->
<!ELEMENT TW (#PCDATA)>
<!--
  VALIDITY CONSTRAINT:
  Designates the height in pixels of a BLOCK, GROUP, or
  VIRTUAL_COMPONENT when viewed while dependencies are hidden(also
  referred to as, Tiled View). Must be a positive integer.
  -->
<!ELEMENT TH (#PCDATA)>
<!--
  VALIDITY CONSTRAINT:
  Designates the minimum width in pixels of a BLOCK, GROUP, or
  VIRTUAL_COMPONENT. The minimum width is used to limit the size of
  a object when a user is resizing it. Must be a positive integer.
  -->
<!ELEMENT MIN_W (#PCDATA)>
<!--
  VALIDITY CONSTRAINT:
  Designates the minimum height in pixels of a BLOCK, GROUP, or
  VIRTUAL_COMPONENT. The minimum width is used to limit the size of
  an object when a user is resizing it. Must be a positive integer.
  -->
<!ELEMENT MIN_H (#PCDATA)>
<!--
  VALIDITY CONSTRAINT:
  Designates the location to which the name of a BLOCK, GROUP, or
  VIRTUAL_COMPONENT will be drawn. This coordinate is relative to
  the left edge of the BLOCK, GROUP or VIRTUAL_COMPONENT.
  -->
<!ELEMENT STR_X (#PCDATA)>
<!--
  VALIDITY CONSTRAINT:
  Designates the width in pixels of the name of a BLOCK, GROUP, or
  VIRTUAL_COMPONENT when it is drawn. Must be a positive integer.
  -->
<!ELEMENT STR_W (#PCDATA)>
<!--
  VALIDITY CONSTRAINT:
  Integer representation of the RGB value of the background color of
  a BLOCK or VIRTUAL_COMPONENT.
  -->
<!ELEMENT COLOR (#PCDATA)>
<!--
  VALIDITY CONSTRAINT:
  Integer representation of the RGB value of the text color of a
  BLOCK, GROUP, or VIRTUAL_COMPONENT.
  -->
<!ELEMENT TEXT_COLOR (#PCDATA)>
<!--
  VALIDITY CONSTRAINT:
  Integer representation of the RGB value of the background color of
  a GROUP.
  -->
<!ELEMENT BACKGROUND_COLOR (#PCDATA)>
```

In this exemplary embodiment, the call outs of a component can be defined as the list of all functions that are called from the component and are defined outside of that component. Such functions may be defined in other components or external dependencies such as static libraries (provided by the user when actually compiling the component) or dynamic libraries (provided when loading and executing the component). An alternative embodiment can define call outs of a component as those messages that are being sent out by the component and must be responded to for the component to execute correctly. Yet another embodiment can define call outs of a component as those external dependencies that must be implemented by another component or external object (such as a static or dynamic library) in order for the component to execute correctly.

In this exemplary embodiment, the callout data is preferably stored as XML documents conforming to the following DTD:

```
<?xml encoding=“ISO8859-1”?>
<!--
  The root document element is called callouts. This may be used
  as a mechanism to identify the kind of file being parsed and
  ensuring that the correct file has been generated.
  -->
<!ELEMENT callouts (GROUP)*>
<!--
  Each GROUP contains three sets of data. These are imposed by the
  implementation (and not by the DTD syntax).
  1. A line of PCDATA specifying an identifier for the GROUP.
  2. A list of function dependencies, one per line, on the component
  whose identifier is specified in item 1 above.
  3. A list of global data dependencies, one per line, on the
  component whose identifier is specified in item 1 above.
  -->
<!ELEMENT GROUP (#PCDATA_FUNCTIONS_DATA)* >
<!-
  Each line (ie PCDATA) specifies the name of a function callout.
  -->
<!ELEMENT FUNCTIONS (#PCDATA) >
<!-
  Each line (i.e. PCDATA) specifies the name of a data callout.
  -->
<!ELEMENT DATA (#PCDATA) >
```

In this exemplary embodiment, the call ins to a component can be defined as the list of all functions that are defined in that component and are being invoked/called from other components. An alternative embodiment may define call ins of a component as a list of messages that are being received from at least one external entity (library, component, etc.) and are being serviced by the component. Yet another embodiment may define call ins of a component as a list of available functionality (or methods, or dependencies) that are being implemented by that component.

In this exemplary embodiment, the call ins data is preferably stored as XML documents conforming to the following DTD:

```
<?xml encoding=“ISO8859-1”?>
<!-
  The root document element is called callins. This may be used as
  a mechanism to identify the kind of file being parsed and ensuring
  that the correct file has been generated.
  -->
<!ELEMENT callins (GROUP)*>
<!-
  Each GROUP contains two sets of data. These are imposed by the
  implementation (and not by the DTD syntax).
  1) A line of PCDATA specifying an identifier for the GROUP.
  2) A list of function calls and data dependencies, one per line,
    from the component whose identifier is specified in item 1
    above.
  IMPLEMENTATION CONSIDERATION:
  Distinction between function and data in item 2 is done at run
  time based on information available n the apilist.xml file.
  -->
<!ELEMENT GROUP (#PCDATA) >
```

In this exemplary embodiment, the function APIs of a component can be defined as the list of all functions that satisfy particular conditions. An example list of conditions may include: (1) the function is defined in the component; (2) the function is not invoked by any other function within that component or the function was explicitly called by one of the other components in the system; and (3) the function is specified as being publicly visible to other components. For example, in the C programming language, number (3) above implies that the type specifier keyword static is not used in the definition or prototype/declaration of the function.

Note that the definition of what constitutes the API for a component can be subjective in various embodiments and, for example, may depend on the programming language used to express the functionality of the component. Consequently, the conditions listed above may advantageously be interpreted as being fluid and able to be modified.

An alternative embodiment may define the function APIs of a component as a list of all those messages that a component is capable of receiving and servicing (or responding to). In this exemplary embodiment, the function API data is preferably stored as XML documents conforming to the following DTD:

```
<?xml encoding=“ISO8859-1”?>
<!-
  The root document element is called apilist. This may be used as
  a mechanism to identify the kind of file being parsed and ensuring
  that the correct file has been generated.
  -->
<!--
  VALIDITY CONSTRAINT:
  Each apilist document contains a list of api functions enclosed
  within a pair of <FUNCTIONS>...</FUNCTIONS> tags followed
  sequentially by a list of global data variables enclosed within a
  pair of <DATA> ..</DATA> tags.
  -->
<!ELEMENT apilist (FUNCTIONS, DATA) >
<!-
  VALIDITY CONSTRAINT:
  Only one api function name per line.
  -->
<!ELEMENT FUNCTIONS (#PCDATA) >
<!-
  VALIDITY CONSTRAINT:
  Only one global data name per line.
  -->
<!ELEMENT DATA (#PCDATA) >
```

In this exemplary embodiment, each executable C language source code file (module) in the native source code base generates a calling tree that may be empty for source code that contains data definitions only and no function bodies.

The calling tree can be generated in the following fashion. For example, each function defined in the source code file may generate a node in the calling tree. Within the body of a function (A), each unique instance of a function call to a function (B) may generate an edge between nodes (A) and (B). The function (B) may or may not be defined in the same source code file. A function can be called directly by its name or indirectly through a function pointer. In the latter case the name of the function pointer can be presented or the name of the function to which the function pointer points can be presented. Function calls that are outside the body of any function definition also generate an edge, for example when an initializer for a global data object invokes a function.

Various alternative embodiments may choose to depict the edge differently. For example, the edge may appear in the comprehensive call tree with the function called presented as the node on one end of the edge and the component name presented as the node on the other end of the edge. In one embodiment, the edges may appear in the calling tree for the file, with the name of the function being called presented as the node at one end of the edge and the name of the source file where the function call was invoked presented as the node at the other end of the edge.

Furthermore, a calling tree for the entire component can be generated by merging the calling trees of all files in the component. For example, nodes with identical names, and with global visibility (ie. function definitions do not specify a static definition) can first be merged into a single node and the edges updated accordingly. Second, nodes that are identical but with static definitions in each file can be kept separate.

In this exemplary embodiment, the data comprising the calling tree for a file as well as the data comprising the comprehensive calling tree for a component is preferably stored as XML documents conforming to the following DTD:

```
<?xml encoding=“ISO8859-1”?>
<!-
  The root document element is called callgraph. This may be used as
  a mechanism to identify the kind of file being parsed and ensuring
  that the correct file has been generated.
  -->
<!-
  VALIDITY CONSTRAINT:
  Each apilist document contains a list of API functions enclosed
  within a pair of <FUNC> ... </FUNC> tags.
  -->
<!ELEMENT callgraph (FUNC)* >
<!-
  VALIDITY CONSTRAINT:
  Each FUNC element represents a function in the source code. Each
  FUNC element consists of the function name, followed by an
  indication of its depth in the call graph followed by a list of
  all other named FUNC elements it invokes.
  -->
<!ELEMENT FUNC (FUNC_NAME, FUNC_DEPTH, USES) >
<!-
  VALIDITY CONSTRAINT:
  This element contains one line of PCDATA. The contents of the line
  specify the name of the current node.
  -->
<!ELEMENT FUNC_NAME (#PCDATA) >
<!-
  VALIDITY CONSTRAINT:
  This element contains one line of PCDATA. The contents of the line
  specify the depth of the current node in the call graph.
  -->
<!ELEMENT FUNC_DEPTH (#PCDATA) >
<!-
  VALIDITY CONSTRAINT:
  Each line contains exactly one successor to the current node in
  the graph. Multiple lines are allowed.
  -->
<!ELEMENT USES (#PCDATA) >
```

In this exemplary embodiment, each API (function API or data API) defined for a component has a place holder associated with it for capturing the documentation (either automatically gathered from source code or specified interactively by a user). Function API descriptors and Data API descriptors can be specified with slightly varying syntax and, in one embodiment, stored in different sub-directories under the directory storing the information model components.

In this exemplary embodiment, the data comprising the function API descriptions is preferably stored as XML documents conforming to the following DTD:

```
<?xml encoding=“ISO8859-1”?>
<!-
  The root document element is called function. This may be used as
  a mechanism to identify the kind of file being parsed and ensuring
  that the correct file has been generated.
  -->
<!-
  Each function is described via 4 sub elements
    1. The name of the function.
    2. A list of parameters.
    3. The return type.
    4. An optional description associated with function.
  -->
<!ELEMENT FUNCTION (NAME, PARAMS, RETURNS,
DESCRIPTION?) >
<!-
  The function name is any character string valid per the semantic
  and syntactic requirements of the programming language.
  -->
<!ELEMENT NAME (#PCDATA)>
<!-
  A parameter list is a list of parameters. Each parameter has a
  type, a name and, optionally, a description.
  -->
<!ELEMENT PARAMS (PTYPE, PNAME, DESCRIPTION?)*>
<!-
  VALIDITY CONSTRAINT:
  The PCDATA must be valid type descriptor in the input language.
  -->
<!ELEMENT PTYPE (#PCDATA) >
<!-
  VALIDITY CONSTRAINT:
  PCDATA must be a syntactically and semantically valid parameter
  name in the input language.
  -->
<!ELEMENT PNAME (#PCDATA) >
<!-
  VALIDITY CONSTRAINT:
  Any valid HTML description including arefs, hrefs, etc.
  -->
<!ELEMENT DESCRIPTION (#PCDATA) >
<!-
  VALIDITY CONSTRAINT:
  The return value must be a syntactically and semantically valid
  return type description in the input language.
  -->
<!ELEMENT RETURNS (#PCDATA_DESCRIPTION?)>
```

In this exemplary embodiment, the data comprising the data API descriptions is preferably stored as XML documents conforming to the following DTD:

```
<?xml encoding=“ISO8859-1”?>
<!--
  The root document element is called DESCRIPTION. This may be
  used as a mechanism to identify the kind of file being
  parsed and ensuring that the correct file has been
  generated.
  -->
<!ELEMENT DESCRIPTION (#PCDATA) >
```

According to this exemplary embodiment, certain architectural refinements and derivatives may be made using the system architect utility. An LIF object is the basis for architectural refinement using the system architect utility. Preferably, the system architect allows design engineers to merge primitive components into a larger component or fragment larger components into smaller ones. The modified architectures are stored as derivative LIF objects that employ a separate specification format. A derivative LIF object can be stored with the original LIF object and advantageously does not modify the original LIF object.

For example, an information model may originally consist of components A, B, C, D, and E as determined by the information model generator. Subsequently, certain architectural refinements are made, including: (1) component A is fragmented into components A1 and A2; (2) component B is fragmented into components B1, B2, and B3; and (3) components C and D are merged into new component X. Component E remains unchanged. Following this example, the component list after the refinement is made by the system architect includes components A1, A2, B1, B2, B3, X, and E.

Additionally, the newly created component X has a corresponding derivative LIF object. Furthermore, derivative LIF objects for components A1, A2, B1, B2, B3, and X will be created by the system architect during the process of making the refinements. The LIF objects for components A and B are still available, although they are not used by the model viewer or other components of the system. After the refinements, the component list will indicate to the model viewer the list of components to present to the user (A1, A2, B1, B2, B3, X) and the list of components to not present to the user (A, B, C, D).

Continuing the example, in a later iteration the architecture is refined such that (1) components A1 and A2 are deleted and component A is reinstated; (2) components B1 and X are merged into new component Y; and (3) components B2 and E are merged into new component Z. Component B3 remains unchanged. The results of the refinements cause the derivative LIF objects for components A1 and A2 to be deleted and also causes derivative LIF objects for new components Y and Z to be created.

After the second set of refinements, the new component list includes A, B3, Y, and Z. Advantageously, although components B1 and B2 are not used after the second set of refinements, they are retained so as to allow subsequent re-fragmentation of component Y or Z (or both) into their constituent parts.

While the particular system and method for the manipulation of software herein shown and described in detail is fully capable of attaining the above described objects of this invention, it is to be understood that the description and drawings represent the presently preferred embodiment of the invention and are, as such, a representative of the subject matter which is broadly contemplated by the present invention. It is further understood that the scope of the present invention fully encompasses other embodiments that may become obvious to those skilled in the art, and that the scope of the present invention is accordingly limited by nothing other than the appended claims.

What is claimed is:

1. An information model representing a software architecture, comprising:
a plurality of language independent format objects, each language independent format object representing a discrete component, wherein the components are structurally related into an information model according to a software architecture.

2. The information model of claim 1, wherein a language independent format object comprises:
one or more XML files conforming to a document type definition describing a particular component; and
one or more documentation objects containing information pertaining to the particular component.

3. The information model of claim 1, further comprising:
one or more derivative language independent format objects, wherein a derivative language independent format object represents two or more combined language independent format objects; and
a hierarchical structure relating the plurality of language independent format objects and the derivative language independent format objects into a software architecture.

4. The information model of claim 1, further comprising:
one or more derivative view objects, wherein a derivative view object contains a structural relationship between two or more language independent format objects such that the one or more derivative view objects, in combination with the language independent format objects reflect a software architecture.

5. The information model of claim 1, wherein the software architecture is derived from a body of source code.

6. A system for creating an information model representing an inherent software architecture derived from a body of source code, comprising:
an information model generator having a parser and a composer, the parser configured to extract program fragments from a body of source code and create a plurality of language dependent format objects, the composer configured to convert language dependent format objects into language independent format objects, wherein each language independent format object represents a discrete component in an information model.

7. The system of claim 6 wherein the composer is further configured to create a derivative language independent format object, the derivative language independent format object comprising two or more language independent format objects and representing a discrete component in the information model.

8. The system of claim 6 wherein the composer is further configured to analyze a file system structure of the body of source code and create a derivative view object, the derivative view object relating two or more language independent format objects into a discrete component in the information model based on the file system structure of the body of source code.

9. The system of claim 6 wherein the composer is further configured to analyze a configuration file and create a derivative view object, the derivative view object relating two or more language independent format objects into a discrete component based on the configuration file.

10. A method for creating an information model representing an inherent software architecture derived from a body of source code, comprising:
extracting program fragments from a body of source code;
converting the program fragments to a language independent format; and
creating a plurality of language independent format objects, wherein each language independent format object contains related program fragments from the body of source and represents a discrete component in an information model.

11. The method of claim 10, wherein the related program fragments are related by data dependencies, functional dependencies, and control flow indicators.

12. The method of claim 11, wherein the data dependencies comprise variables passed through function calls and shared global variables.

13. The method of claim 11, wherein the functional dependencies comprise incoming function calls and outgoing function calls.

14. The method of claim 10, further comprising the step of:
creating one or more derivative language independent format objects, wherein a derivative language independent format object comprises two or more language independent format objects.

15. The method of claim 10, further comprising the step of:
creating one or more derivative view objects, wherein a derivative view object relates two or more language independent format objects into a discrete component in the information model.

16. The method of claim 15, wherein the two or more language independent format objects are related based on the file system structure of the body of source code.

17. The method of claim 15, wherein the two or more language independent format objects are related based on a configuration file.

18. A method for creating an information model representing an inherent software architecture derived from a body of source code, comprising:
parsing a body of source code to extract data dependencies, functional dependencies, and control flow indicators;
creating a plurality of language dependent format objects, each language dependent format object comprising an abstract syntax tree representing related program fragments within the body of source code; and
converting each language dependent format object into a language independent format object, wherein each language independent format object represents a discrete component in an information model.

19. The method of claim 18, wherein the related program fragments are related by data dependencies, functional dependencies, and control flow indicators.

20. The method of claim 19, wherein the data dependencies comprise variables passed through function calls and shared global variables.

21. The method of claim 19, wherein the functional dependencies comprise incoming function calls and outgoing function calls.

22. The method of claim 18, further comprising the step of:
creating one or more derivative language independent format objects, wherein a derivative language independent format object comprises two or more language independent format objects.

23. The method of claim 18, further comprising the step of:
creating one or more derivative view objects, wherein a derivative view object relates two or more language independent format objects into a discrete component in the information model.

24. The method of claim 23, wherein the two or more language independent format objects are related based on the file system structure of the body of source code.

25. The method of claim 23, wherein the two or more language independent format objects are related based on a configuration file.

26. A method for creating an information model representing a software architecture, comprising:
creating a plurality of language independent format objects, wherein each language independent format object represents a discrete component in an information model.

27. The method of claim 26, further comprising:
arranging the plurality of language independent format objects into a hierarchical structure representing a software architecture.

28. The method of claim 27, wherein the plurality of language independent format objects are arranged according to data dependencies, functional dependencies, and control flow indicators.

29. The method of claim 28, wherein the data dependencies comprise variables passed through function calls and shared global variables.

30. The method of claim 28, wherein the functional dependencies comprise incoming function calls and outgoing function calls.

31. The method of claim 26, further comprising the step of:
creating one or more derivative language independent format objects, wherein a derivative language independent format object comprises two or more language independent format objects.

32. The method of claim 26, further comprising the step of:
creating one or more derivative view objects, wherein a derivative view object relates two or more language independent format objects into a discrete component in the information model.

33. A system for manipulating an information model representing a software architecture, comprising:
an information model viewer configured to provide a visual presentation of the information model representing the software architecture; and
a system architect configured to modify the software architecture.

34. The system of claim 33, wherein the information model viewer further comprises:
a data dependency viewer configured to present the data dependencies between components of the information model;
a functional dependency viewer configured to present the functional dependencies between components of the information model; and
a calling tree viewer configured to present the control flow between program fragments contained within a component of the information model.

35. The system of claim 34, further comprising:
a search results viewer configured to present the results of searches conducted within one or more information models or within one or more components of one or more information models.

36. The system of claim 33, further comprising:
a language specific viewer configured to provide a visual presentation of the information model representing the software architecture according to one or more programming language paradigms.

37. The system of claim 33, wherein the system architect further comprises:
an architect designer configured to reorganize the hierarchical component structure of the information model.

38. The system of claim 37, wherein the architect designer is further configured to merge two or more components together into a single component.

39. The system of claim 38, wherein the architect designer is further configured to fragment a merged component into two or more components.

40. The system of claim 37, wherein the system architect further comprises:
an architect enhancer configured to add new components to the information model.

41. The system of claim 40, wherein the system architect further comprises:
an architect creator configured to create new components and relate the newly created components into a new information model having no underlying body of source code.

42. The system of claim 41, wherein the system architect further comprises:
an architect optimizer configured to extract functionally related components of an information model and create a new information model having a reduced set of components serving a desired function.

43. The system of claim 33, further comprising:
an information model editor having a text interface and a file interface, the text interface configured to allow editing of documentation associated with the information model and the file interface configured to receive new or modified documentation files associated with the information model.

44. The system of claim 33, further comprising:
an information model builder having a text interface and a file interface, the text interface configured to allow editing of source code files included with the body of source code and the file interface configured to receive new or modified source code files for inclusion with the body of source code.

45. The system of claim 44, wherein the file interface is further configured to provide source code files from the body of source code.

46. The system of claim 33, further comprising:
an information model search engine configured to accept a query, search the information model, and provide search results.

47. The system of claim 33, further comprising:
an information model document generator configured to compile a plurality of documentation objects into an information model document.

48. The system of claim 33, further comprising:
an information model difference generator configured to compare at least two information models and determine the differences between the at least two information models.

49. A method for manipulating an information model having a plurality of components arranged in a hierarchical structure representing a software architecture, comprising:
merging two or more components into a compound component.

50. The method of claim 49, further comprising:
modifying the hierarchical structure between two or more components;

51. A method for manipulating an information model having a plurality of components arranged in a hierarchical structure representing a software architecture, comprising:
fragmenting a compound component into its constituent components.

52. The method of claim 51, further comprising:
modifying the hierarchical structure between two or more components;

53. A method for manipulating an information model having a plurality of components arranged in a hierarchical structure representing a software architecture, comprising:
modifying the hierarchical structure between two or more components in an information model;
merging two or more components into a compound component; and
fragmenting a compound component into its constituent components.

54. The method of claim 53, wherein the modifying step further comprises:
selecting a first component; and
promoting the first component in relation to a second component.

55. The method of claim 53, wherein the modifying step further comprises:
selecting a first component; and
demoting the first component in relation to a second component.

56. The method of claim 53, wherein the merging step further comprises merging a component and a first compound component into a second compound component.

57. The method of claim 53, wherein the merging step further comprises merging a first compound component and a second compound component into a third compound component.

58. The method of claim 53, wherein the fragmenting step further comprises fragmenting a compound component into two or more components.

59. The method of claim 53, wherein the fragmenting step further comprises fragmenting a compound component into a component and a compound component.

60. The method of claim 53, wherein the fragmenting step further comprises fragmenting a compound component into a first compound component and a second compound component.

61. The method of claim 53, further comprising editing documentation associated with the information model through a documentation text editor.

62. The method of claim 53, further comprising uploading new or modified documentation files through a file interface.

63. The method of claim 53, further comprising compiling documentation associated with the information model into an information model document.

64. The method of claim 53, further comprising:
creating a new component in the information model; and
organizing the new component within the hierarchical structure of the information model.

65. The method of claim 53, further comprising searching the information model in response to a query and providing search results.

66. The method of claim 53, further comprising:
comparing a first information model to a second information model; and
generating a difference set containing the differences between the first information model and the second information model identified by the comparison.

67. The method of claim 66, wherein the difference set comprises a new information model.

68. A method for manipulating an information model derived from a body of source code, comprising:
establishing a connection with a server computer;
requesting an information model from the server, wherein the information model is derived from a particular body of source code; and
receiving a visual presentation of the requested information model comprising a plurality of hierarchically arranged components and a plurality of documentation files.

69. The method of claim 68, wherein the plurality of components comprises:
a plurality of single components;
a plurality of compound components, wherein a compound component comprises two or more single components; and
a plurality of data dependencies, functional dependencies, and control indicators, wherein data dependencies, functional dependencies, and control indicators relate the single components and compound components.

70. The method of claim 69, wherein a compound component comprises one or more single components and one or more compound components.

71. The method of claim 69, wherein a compound component comprises two or more compound components.

72. The method of claim 68, further comprising:
viewing a compound component and a sub-component of the compound component;
selecting the sub-component; and
viewing the data dependencies, functional dependencies, and control indicators of the sub-component.

73. The method of claim 68, further comprising:
viewing a documentation file; and
editing the documentation file.

74. The method of claim 68, further comprising:
rearranging the hierarchical structure of the components.

75. The method of claim 68, further comprising:
submitting a search request for a particular component;
receiving a search response, wherein the search response presents the requested component according to its relative position in the hierarchical structure.

76. The method of claim 75, wherein the search response further presents each higher level component disposed between the requested component and a highest level component.

77. A system for manipulating an information model having a plurality of components arranged in a hierarchical structure representing a software architecture, comprising:
means for providing a visual presentation of the information model representing the software architecture; and
means for modifying the software architecture.

78. The system of claim 77, wherein the information model viewer further comprises:
means for presenting the data dependencies between components of the information model;
means for presenting the functional dependencies between components of the information model; and
means for presenting the control flow between program fragments contained within a component of the information model.

79. The system of claim 78, further comprising:
means for presenting a result of a search conducted within one or more information models or within one or more components of one or more information models.

80. The system of claim 79, further comprising:
means for presenting the information model as if the underlying body of source code was in a particular programming language.

81. The system of claim 77, wherein the system architect further comprises:
means for reorganizing the hierarchical component structure of the information model;
means for merging two or more components together into a compound component;
means for fragmenting a compound component into two or more components; and
means for adding new components to the information model.

82. The system of claim 81, wherein the system architect further comprises:
means for creating new components; and
means for relating the newly created components into a new information model having no underlying body of source code.

83. The system of claim 81, wherein the system architect further comprises:
means for extracting functionally related components of an information model; and
means for creating a new information model having a reduced set of components serving a desired function.

84. The system of claim 77, further comprising:
means for editing documentation associated with the information model; and
means for receiving new or modified documentation files associated with the information model.

85. The system of claim 77, further comprising:
means for editing source code files included with the body of source code; and
means for receiving new or modified source code files for inclusion with the body of source code.

86. The system of claim 85, wherein the means for receiving new or modified source code files further comprises:
means to provide source code files from the body of source code.

87. The system of claim 77, further comprising:
means for accepting a query;
means for searching the information model; and
means for providing results.

88. The system of claim 77, further comprising:
means for compiling a plurality of documentation objects into an information model document.

89. The system of claim 77, further comprising:
means for comparing at least two information models; and
means for determining the differences between the at least two information models.

90. A computer readable medium having stored thereon one or more sequences of instructions for causing one or more microprocessors to perform the steps for manipulating an information model having a plurality of components arranged in a hierarchical structure representing a software architecture, the steps comprising:
merging two or more components into a compound component.

91. The computer readable medium of claim 90 further comprising the step of:
modifying the hierarchical structure between two or more components in an information model.

92. A computer readable medium having stored thereon one or more sequences of instructions for causing one or more microprocessors to perform the steps for manipulating an information model having a plurality of components arranged in a hierarchical structure representing a software architecture, the steps comprising:
fragmenting a compound component into its constituent components.

93. The computer readable medium of claim 92 further comprising the step of:
modifying the hierarchical structure between two or more components in an information model.

94. A computer readable medium having stored thereon one or more sequences of instructions for causing one or more microprocessors to perform the steps for manipulating an information model having a plurality of components arranged in a hierarchical structure representing a software architecture, the steps comprising:
modifying the hierarchical structure between two or more components in an information model;
merging two or more components into a compound component; and
fragmenting a compound component into its constituent components.

95. The computer readable medium of claim 94, wherein the modifying step further comprises:
selecting a first component; and
promoting the first component in relation to a second component.

96. The computer readable medium of claim 94, wherein the modifying step further comprises:
selecting a first component; and
demoting the first component in relation to a second component.

97. The computer readable medium of claim 94, wherein the merging step further comprises merging a component and a first compound component into a second compound component.

98. The computer readable medium of claim 94, wherein the merging step further comprises merging a first compound component and a second compound component into a third compound component.

99. The computer readable medium of claim 94, wherein the fragmenting step further comprises fragmenting a compound component into two or more components.

100. The computer readable medium of claim 94, wherein the fragmenting step further comprises fragmenting a compound component into a component and a compound component.

101. The computer readable medium of claim 94, wherein the fragmenting step further comprises fragmenting a compound component into a first compound component and a second compound component.

102. The computer readable medium of claim 94, further comprising editing documentation associated with the information model through a documentation text editor.

103. The computer readable medium of claim 94, further comprising uploading new or modified documentation files through a file interface.

104. The computer readable medium of claim 94, further comprising compiling documentation associated with the information model into an information model document.

105. The computer readable medium of claim 94, further comprising:
creating a new component in the information model; and
organizing the new component within the hierarchical structure of the information model.

106. The computer readable medium of claim 94, further comprising searching the information model in response to a query and providing search results.

107. The computer readable medium of claim 94, further comprising:
comparing a first information model to a second information model; and
generating a difference set containing the differences between the first information model and the second information model identified by the comparison.

108. A system for manipulating an information model having a plurality of components arranged in a hierarchical structure representing a software architecture, comprising:
an information model viewer having a data dependency viewer capable of presenting the data dependencies between components of the information model and a functional dependency viewer capable of presenting the functional dependencies between components of the information model;
a system architect having an architect designer capable of reorganizing the hierarchical component structure of the information model;
an information model editor having a text interface capable of allowing editing of documentation associated with the information model and a file interface capable of receiving new or modified documentation files associated with the information model; and
an information model builder having a text interface capable of allowing editing of source code files included with the body of source code and a file interface capable of receiving new or modified source code files for inclusion with the body of source code.

109. The system of claim 108, further comprising:
an information model viewer having a calling tree viewer capable of presenting the control flow between components of the information model and within a single component of the information model, and a language specific viewer capable of presenting the information model according to one or more programming language paradigms;
a system architect having an architect enhancer capable of adding new components to the information model, an architect creator capable of creating new components and relating the newly created components into a new information model having no underlying body of source code, an architect optimizer capable of extracting functionally related components of an information model and creating a new information model having a reduced set of components serving a desired function;
an information model search engine capable of accepting a query, searching the information model, and providing search results;
an information model document generator capable of compiling a plurality of documentation objects into an information model document; and
an information model difference generator capable of comparing at least two information models and determining differences between the at least two information models.
